(19) United States
(12) Patent Application Publication
(10) Pub. No.: US 2024/0346978 A1
(43) Pub. Date: Oct. 17, 2024

(54) ELECTRONIC DEVICE AND DISPLAY SYSTEM

(71) Applicant: Japan Display Inc., Tokyo (JP)

(72) Inventor: Kentaro OKUYAMA, Tokyo (JP)

(73) Assignee: Japan Display Inc., Tokyo (JP)

(21) Appl. No.: 18/630,159

(22) Filed: Apr. 9, 2024

(30) Foreign Application Priority Data
Apr. 11, 2023 (JP) 2023-064250

(51) Int. Cl. G09G 3/20; G02F 1/1333; G02F 1/137; G09B 5/02; G09G 3/36

(52) U.S. Cl. CPC G09G 3/2096; G02F 1/13338; G02F 1/137; G09G 3/36; G09G 3/3674; G09B 5/02; G09G 2310/08; G09G 2320/0666; G09G 2354/00; G09G 2370/00

(57) ABSTRACT

According to one embodiment, an electronic device includes a display panel, a first sensor, a memory unit, and a controller. During a first period, the controller generates first image data, stores the first image data in the memory unit, and displays a first character in a display area of the display panel. During a second period, the controller generates second image data, and records the second image data in the memory unit. During a third period, the controller displays a second character instead of the first character, in the display area. The second character is a character obtained by flipping the first character.

### CROSS-REFERENCE TO RELATED APPLICATIONS

This application is based upon and claims the benefit of priority from Japanese Patent Application No. 2023-064250, filed Apr. 11, 2023, the entire contents of which are incorporated herein by reference.

### FIELD

Embodiments described herein relate generally to an electronic device and a display system.

### BACKGROUND

Blackboards, whiteboards, and the like are routinely used in school classes. When a teacher is writing or pointing out letters, the teacher turns his/her back to students. When using a blackboard or whiteboard, the teacher can hardly recognize the students' expressions, and the teacher and students are less likely to look at each other.

For this reason, the students' level of understanding cannot improved, and the quality of communication between the teacher and the students is reduced, for example. In particular, when the teacher explains while writing letters on the blackboard or whiteboard, the teacher is almost always speaking with his/her back turned to students. For example, the teacher's recognition that the teacher faces the students may be easily lowered. Similar cases are seen in a wide range of our daily life, such as office meetings, lectures, license centers, cooking classes, and so on.

In contrast, the understanding of users (e.g., students) through electronic contents is promoted by use of large electronic blackboards, tablet terminals, and the like in place of blackboards and whiteboards. However, since the users spend more time looking at the terminals or look at the terminals more frequently, the perception of facing may be further reduced.

### BRIEF DESCRIPTION OF THE DRAWINGS

FIG. 1 is a block diagram showing an electronic device according to a first embodiment, using functional blocks.

FIG. 2 is a plan view showing a configuration of a display device of the electronic device shown in FIG. 1.

FIG. 3 is a cross-sectional view showing a part of the display device and a first sensor shown in FIG. 1.

FIG. 4 is a view showing main components of the display device shown in FIG. 2.

FIG. 5A is a view schematically showing a display liquid crystal layer in a transparent state.

FIG. 5B is a view schematically showing the display liquid crystal layer in a scattered state.

FIG. 6A is a cross-sectional view showing a display panel in a case where the display liquid crystal layer is in the transparent state.

FIG. 6B is a cross-sectional view showing the display panel in a case where the display liquid crystal layer is in the scattered state.

FIG. 7 is a plan view showing a configuration of a first sensor in FIG. 1 and FIG. 3.

FIG. 8 is a graph showing the scattering characteristics of the display liquid crystal layer.

FIG. 9A is a view showing an outline of a one-line inversion drive scheme.

FIG. 9B is a view showing an outline of a two-line inversion drive scheme.

FIG. 9C is a view showing an outline of a frame-inversion drive scheme.

FIG. 10 is a chart showing an example of a common voltage and a source line voltage in the display drive.

FIG. 11 is a chart showing an example of the common voltage and the source line voltage in the transparent drive.

FIG. 12 is a chart showing another example of the common voltage and the source line voltage in the transparent drive.

FIG. 13 is a view showing a configuration example of a timing controller shown in FIG. 4.

FIG. 14 is a plan view showing the display panel from a second display surface side, illustrating a usage example of the electronic device, and a state in which a teacher inputs a character in a first sensor, a scattering voltage and a first transparent voltage are applied to the display liquid crystal layer, and the character is displayed in a display area of the display panel.

FIG. 15 is a cross-sectional view showing the display panel of FIG. 14 along line XV-XV.

FIG. 16 is an exploded perspective view showing a part of the electronic device of the first embodiment, showing the display panel and the first sensor from the second display surface side, and illustrating a state in which the character input by the teacher is flipped in the display area of the display panel and the teacher faces the students through the display panel and the first sensor.

FIG. 17 is a circuit diagram showing a part of a gate driver and several gate lines shown in FIG. 4 and the like.

FIG. 18 is a timing chart illustrating an example of an operation of the electronic device according to the first embodiment.

FIG. 19 is a plan view showing the display panel from the second display surface side in the electronic device according to the second embodiment, illustrating an example of the use of the electronic device, and a state in which the character input to the sensor by the teacher is displayed in the first display area and the character input by the teacher is flipped in the second display area.

FIG. 20 is a block diagram showing an electronic device according to a third embodiment, using functional blocks.

FIG. 21 is an exploded perspective view showing parts of the electronic device according to the third embodiment, illustrating a display alignment film, a display liquid crystal layer, and a light control panel.

FIG. 22A is a view schematically showing a display liquid crystal layer in the transparent state and a light source unit.

FIG. 22B is a view schematically showing the display liquid crystal layer in the scattered state and the light source unit.

FIG. 23 is a graph showing change in transmittance to voltage in S-polarized light, P-polarized light, and N-polarized light.

FIG. 24 is a cross-sectional view showing a light control panel of the electronic device according to the third embodiment.

FIG. 25 is an exploded perspective view showing parts of the electronic device according to the third embodiment, illustrating a display panel, a control alignment film, and a control liquid crystal layer.

FIG. 26A is a view schematically showing a control liquid crystal layer in a state in which the light control panel of the electronic device according to the third embodiment is switched to a light-shielding state.

FIG. 26B is a view schematically showing the control liquid crystal layer in a state in which the light control panel of the electronic device according to the third embodiment is switched to a transmissive state.

FIG. 27 is a plan view showing the display panel from the first display surface side, in the electronic device according to the third embodiment, illustrating an example of use of the electronic device and a state in which the character input to the sensor by the teacher is displayed in front of the light control area of the first display surface.

FIG. 28 is a plan view showing the display panel and the light control panel from the second display surface side, in the electronic device according to the third embodiment, illustrating an example of use of the electronic device, and a state in which the character displayed in front of the light control area of the second display surface is hidden by the light control panel.

FIG. 29 is a view showing a part of a display system according to a fourth embodiment, showing a display panel viewed from a side of a sensor and a first display surface of an electronic device, and an input device, illustrating an example of use of the display system, and a state in which the input device using an input signal with color information displays a character input to the sensor in a color other than achromatic on the display panel.

FIG. 30 is a view showing a part of a display system according to a fifth embodiment, showing a display panel from a second display surface side of an electronic device, and a communication terminal, and illustrating an example of use of the display system, and a state in which by transmitting an input signal from the communication terminal to the electronic device, a character displayed on the communication terminal is also displayed in a display area of the display panel.

FIG. 31 is a block diagram showing the electronic device according to modified example 1 of the first embodiment, using functional blocks.

FIG. 32 is a plan view showing a configuration of a second sensor shown in FIG. 31.

FIG. 33 is a view showing the main components of the display device of the electronic device according to modified example 2 of the first embodiment.

FIG. 34 is a view showing a configuration example of a Vcom pull-in circuit shown in FIG. 33.

### DETAILED DESCRIPTION

In general, according to one embodiment, there is provided an electronic device comprising: a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode; a first sensor including a plurality of first detection electrodes opposed to at least the display area and detecting input information; a memory unit; and a controller controlling drive of the plurality of pixel electrodes, the common electrode, the plurality of first detection electrodes, and the memory unit. During a first period, the controller generates first image data based on the input information detected by the first sensor, stores the first image data in the memory unit, and displays a first character based on the first image data stored in the memory unit, in the display area of the display panel. During a second period following the first period, the controller generates second image data based on the first image data stored in the memory unit, and records the second image data in the memory unit. During a third period following the second period, the controller displays a second character based on the second image data instead of the first character, in the display area of the display panel. The second character is a character obtained by flipping the first character.

According to another embodiment, there is provided a display system comprising: an electronic device; and an input device capable of outputting an input signal with color information. The electronic device comprises: a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode; a first sensor including a plurality of first detection electrodes opposed to at least the display area and detecting input information; a memory unit; a controller controlling drive of the plurality of pixel electrodes, the common electrode, the plurality of first detection electrodes, and the memory unit; and a light source unit having drive controlled by the controller, being located outside an area opposed to the display area of the display panel, and emitting light of a color other than an achromatic color to the display function layer. During a first period, the controller generates first image data based on the input information detected by the first sensor, stores the first image data in the memory unit, and displays a first character based on the first image data stored in the memory unit, in the display area of the display panel. During a second period following the first period, the controller generates second image data based on the first image data stored in the memory unit, and records the second image data in the memory unit. During a third period following the second period, the controller displays a second character based on the second image data instead of the first character, in the display area of the display panel. The second character is a character obtained by flipping the first character. The input device outputs a first input signal with information on a first display color. When the input information detected by the first sensor is the first input signal with the information on the first display color, the controller displays a character of the first display color.

According to yet another embodiment, there is provided a display system comprising: an electronic device; and a communication terminal including a display unit displaying an input character. The electronic device comprises: a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode; a first sensor including a plurality of first detection electrodes opposed to at least the display area and detecting input information; a memory unit; a communication unit capable of communicating with the communication terminal; and a controller controlling drive of the plurality of pixel electrodes, the common electrode, the plurality of first detection electrodes, the memory unit, and the communication unit. When transmitting an input signal indicating the character from the communication terminal to the electronic device, the controller generates image data based on the input signal received by the communication unit, stores the image data in the memory unit, and displays the character based on the image data stored in the memory unit, in the display area of the display panel.

Embodiments will be described hereinafter with reference to the accompanying drawings. The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Besides, in the specification and drawings, the same elements as those described in connection with preceding drawings are denoted by like reference numbers, and a detailed description thereof is omitted unless necessary.

In each of the embodiments, an electronic device in which a polymer dispersed liquid crystal is applied to a display panel will be described. The electronic device of each of the embodiments can be used for various electronic devices such as personal computers, tablet terminals, and smartphones.

### First Embodiment

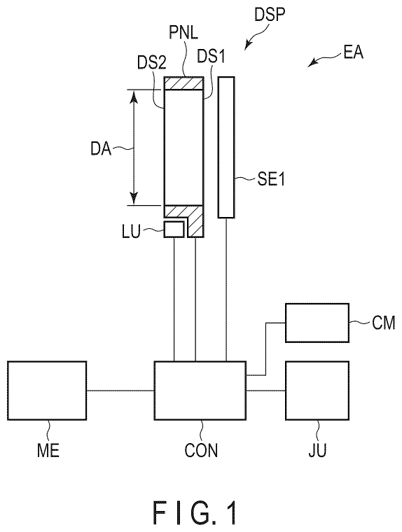

FIG. 1 is a block diagram showing an electronic device EA according to a first embodiment, using functional blocks. As shown in FIG. 1, the electronic device EA comprises a display panel PNL, a light source unit LU, a sensor SE1 serving as a first sensor, a memory unit ME, and a controller CON.

The display panel PNL has a display area DA which displays images and transmits external light. In the drawing, parts of the display panel PNL other than the display area DA are represented by hatch lines. The display panel PNL has a first display surface DS1 and a second display surface DS2 on the opposite side of the first display surface. The light source unit LU is located outside an area of the display panel PNL, which is opposed to the display area DA. The sensor SE1 is opposed to at least the display area DA and can detect input information. In the present embodiment, the sensor SE1 is arranged opposite the first display surface DS1 of the display panel PNL. The display panel PNL, the light source unit LU, the sensor SE1, and the memory unit ME are each connected to the controller CON.

The controller CON can control the drive of each of the display panel PNL, the light source unit LU, the sensor SE1 (i.e., first detection electrodes Sx1 to be described later), the memory unit ME, a determination unit JU, and a communication unit CM. The controller CON can synchronize the drive of the display panel PNL, the light source unit LU, the sensor SE1, and the memory unit ME. The controller CON, the display panel PNL, and the light source unit LU constitute the display device DSP.

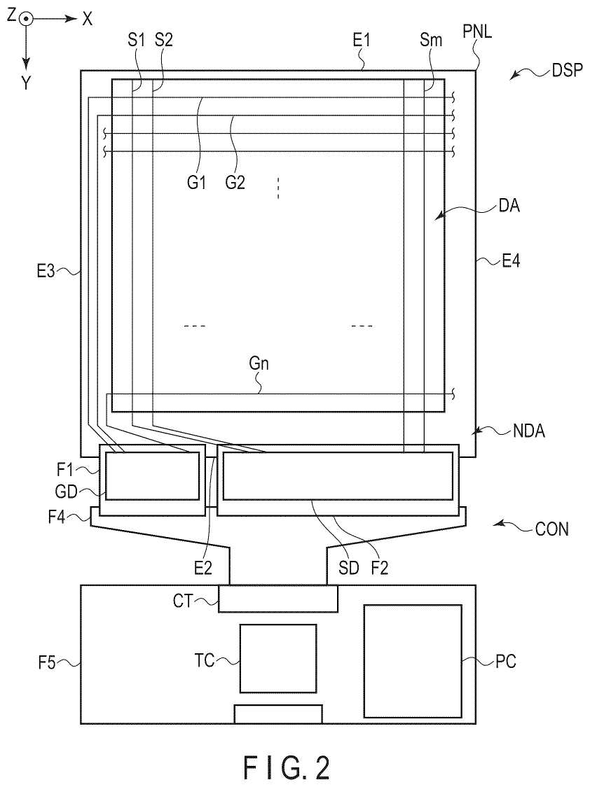

FIG. 2 is a plan view showing a configuration of the display device DSP of the electronic device EA shown in FIG. 1.

As shown in FIG. 2, a first direction X and a second direction Y are directions which intersect each other, and a third direction Z is a direction which intersects the first direction X and the second direction Y. The first direction X corresponds to the row direction while the second direction Y corresponds to the columnar direction. In one example, the first direction X, the second direction Y, and the third direction Z are orthogonal to one another but may intersect at an angle other than 90 degrees. In the present specification, a direction toward a distal part of an arrow indicating the third direction Z is referred to as upward (or, simply above) or forward, and a direction opposite to the distal part of the arrow is referred to as downward (or, simply below) or backward.

The display device DSP comprises the display panel PNL, wiring boards F1, F2, F4, and F5, and the like. The display panel PNL has a display area DA on which images are displayed and a frame-shaped non-display area NDA surrounding the display area DA. The display area DA includes n gate lines G (G1 to Gn), m source lines S (S1 to Sm), and the like. Incidentally, both n and m are positive integers, and n may be equal to m, or n may be different from m. The plurality of gate lines G extend in the first direction X and are arranged to be spaced apart in the second direction Y. In other words, the plurality of gate lines G extend in the row direction. The plurality of source lines S extend in the second direction Y and are arranged to be spaced apart in the first direction X. The display panel PNL includes end portions E1 and E2 along the first direction X, and end portions E3 and E4 along the second direction Y.

The wiring board F1 includes a gate driver GD. The plurality of gate lines G are connected to the gate driver GD. The wiring board F2 comprises a source driver SD. The plurality of source lines S are connected to the source driver SD. Each of the wiring boards F1 and F2 is connected to the display panel PNL and the wiring board F4. The wiring board F5 includes a timing controller TC, a power supply circuit PC, and the like. The wiring board F4 is connected to a connector CT of the wiring board F5. Incidentally, the wiring boards F1 and F2 may be replaced with a single wiring board. Alternatively, the wiring boards F1, F2, and F4 may be replaced with a single wiring board. The gate driver GD, the source driver SD, and the timing controller TC described above constitute the controller CON of the present embodiment, and the controller CON is configured to control the drive of each of the plurality of gate lines G, the plurality of source lines S, a plurality of pixel electrodes to be described later, a common electrode to be described later, the light source unit LU, and the sensor SE1.

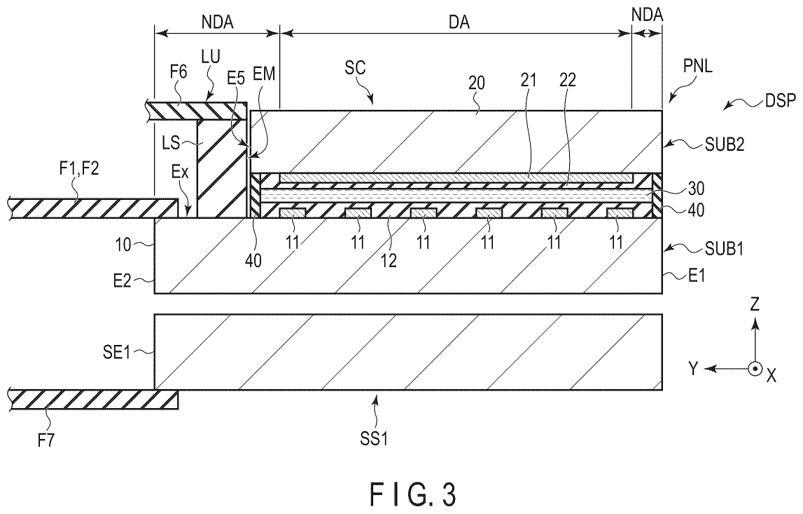

FIG. 3 is a cross-sectional view showing several parts of the display device DSP shown in FIG. 1, and the sensor SE1. Main portions alone in the cross-section of the display device DSP in a Y-Z plane defined by the second direction Y and the third direction Z will be described here.

As shown in FIG. 3, the display panel PNL comprises a first substrate (first display substrate) SUB1, a second substrate (second display substrate) SUB2, a liquid crystal layer (display liquid crystal layer) 30 serving as a display function layer, and the like.

The first substrate SUB1 includes a transparent substrate 10, a plurality of pixel electrodes 11, an alignment film (first display alignment film) 12, and the like. The second substrate SUB2 includes a transparent substrate 20, a common electrode 21, an alignment film (second display alignment film) 22, and the like. The plurality of pixel electrodes 11 and the common electrode 21 are formed of, for example, a transparent conductive material such as indium tin oxide (ITO) or indium zinc oxide (IZO), and are located in the display area DA. Each of the alignment film 12 and the alignment film 22 is in contact with the liquid crystal layer 30.

The liquid crystal layer 30 is located in at least the display area DA. The liquid crystal layer 30 contains a polymer dispersed liquid crystal, and is held between the first substrate SUB1 and the second substrate SUB2. The liquid crystal layer 30 of the present embodiment uses reverse mode polymer dispersed liquid crystal (R-PDLC). The liquid crystal layer 30 maintains the parallelism of light to be made incident when a voltage to be applied is low, and scatters the light to be made incident when the voltage to be applied is high.

The first substrate SUB1 and the second substrate SUB2 are adhered by a sealing material 40. The first substrate SUB1 includes an extending portion EX which further extends than an end portion E5 of the transparent substrate 20 in the second direction Y.

The wiring boards F1 and F2 are connected to the extending portion EX of the first substrate SUB1.

The light source unit LU is located in the non-display area NDA outside the display area DA. The light source unit LU is located on the side surface of the display panel PNL. The light source unit LU comprises a light emitting element LS, a wiring board F6, and the like. The light emitting element LS is connected to the wiring board F6 and is located on the extending portion EX. The light emitting element LS includes a light emitting portion (light emitting surface) EM opposed to the end portion E5. Illumination light emitted from the light emitting portion EM is made incident on the end portion E5 and propagates through the display panel PNL as described later. However, the display device DSP may be configured without the wiring board F6. In this case, the light emitting element LS is controlled to be driven by the controller CON via the wiring board F1 or the wiring board F2.

The sensor SE1 is opposed to at least the display area DA of the display panel PNL. The sensor SE1 is connected to the wiring board F7 and is connected to the controller CON described above via the wiring board F7.

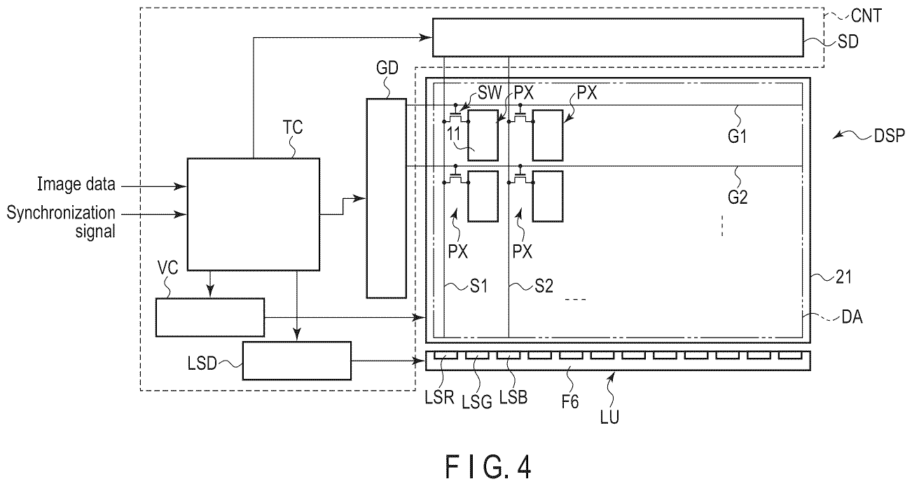

FIG. 4 is a view showing main components of the display device DSP shown in FIG. 2.

As shown in FIG. 4, the display device DSP comprises a controller CNT represented by a dashed line in the drawing. The controller CNT includes a timing controller TC, a gate driver GD, a source driver SD, a Vcom circuit VC, a light source driver LSD, and the like.

The timing controller TC generates various signals, based on image data, synchronization signals, and the like input from the outside. In one example, the timing controller TC outputs video signals generated by executing predetermined signal processing, based on the image data, to the source driver SD. In addition, the timing controller TC outputs the control signals generated based on the synchronization signals to each of the gate driver GD, the source driver SD, the Vcom circuit VC, and the light source driver LSD. Details of the timing controller TC will be described later.

The display area DA represented by a two-dot chain line in the drawing includes a plurality of pixels PX. Each of the pixels PX comprises a switching element SW and the pixel electrode 11. The switching element SW is formed of, for example, a thin-film transistor. The switching element SW is electrically connected to the gate line G and the source line S. The plurality of pixel electrodes 11 are located in the display area DA and are arrayed in a matrix. For this reason, for example, the plurality of pixel electrodes 11 are provided in a plurality of rows. The pixel electrode 11 is connected to the source line S via the switching element SW. The common electrode 21 is located in the display area DA. The common electrode 21 is opposed to the plurality of pixel electrodes 11. Unlike the present embodiment, the common electrode 21 may be divided for each of at least one pixel PX, each of the divided electrodes may be connected to the common line, and a common voltage may be applied to the divided electrode.

A gate signal is supplied from the gate driver GD to each of the gate lines G. The video signal (image signal) is supplied from the source driver SD to each of the source lines

S. A common voltage Vcom is supplied from the Vcom circuit VC to the common electrode 21. The video signal supplied to the source line S is applied to the pixel electrode 11 connected to the switching element SW in a period in which the switching element SW becomes a conductive state based on the gate signal supplied to the gate line G. In the following description, supplying the video signal to the pixel electrode 11 to form a potential difference between the pixel electrode 11 and the common electrode 21 may be referred to as writing the video signal (or applying the voltage) to the pixel PX comprising the pixel electrode 11.

The light source unit LU is configured to emit light to the liquid crystal layer 30. In the present embodiment, the light source unit LU is configured to emit light of a color other than achromatic color to the liquid crystal layer 30. The light source unit LU comprises light emitting elements LS of a plurality of colors. For example, the light source unit LU comprises a light emitting element (first light emitting element) LSR which emits light of a first color to the liquid crystal layer 30, a light emitting element (second light emitting element) LSG which emits light of a second color to the liquid crystal layer 30, and a light emitting element (third light emitting element) LSB which emits light of a third color to the liquid crystal layer 30. The first, second, and third colors are colors different from each other. In the present embodiment, the first color is red, the second color is green, and the third color is blue.

The light source driver LSD controls lighting periods of the light emitting elements LSR, LSG, and LSB. As described in detail later, in a drive scheme in which one frame period has a plurality of sub-frame periods, at least one of three light emitting elements LSR, LSG, and LSB is turned on in each sub-frame and the color of the illumination light is switched for each sub-frame.

A configuration example of the display device comprising the liquid crystal layer 30 which is a polymer dispersed liquid crystal layer will be described below.

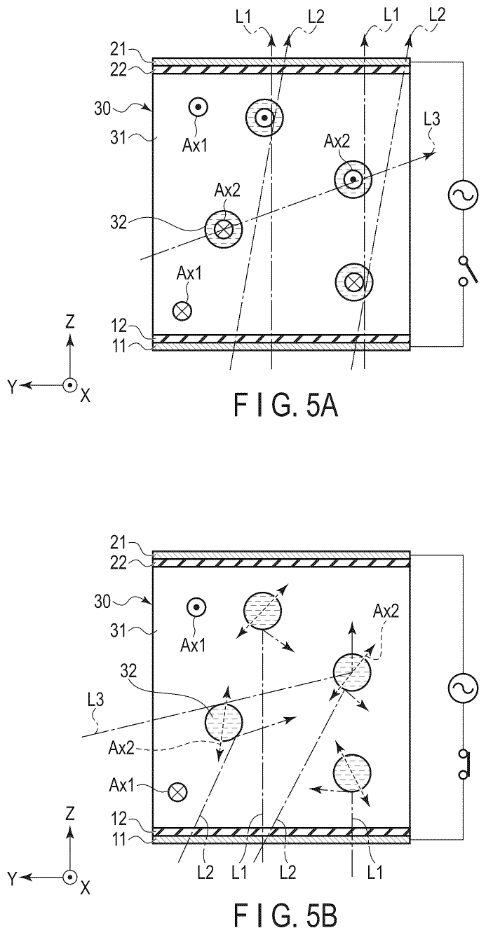

FIG. 5A is a view schematically showing the liquid crystal layer 30 in a transparent state.

As shown in FIG. 5A, the liquid crystal layer 30 contains liquid crystalline polymers 31 and liquid crystalline molecules 32. The liquid crystalline polymer 31 can be obtained by, for example, polymerizing liquid crystalline monomer in a state in which the liquid crystalline monomer is aligned in a predetermined direction by the alignment restriction force of the alignment films 12 and 22. The liquid crystalline molecules 32 are dispersed in the liquid crystalline monomer, and are aligned in a predetermined direction depending on the alignment direction of the liquid crystalline monomer when the liquid crystalline monomer is polymerized. In the present embodiment, the alignment films 12 and 22 are horizontal alignment films that initially align the liquid crystalline monomer and the liquid crystalline molecules 32 along the X-Y plane defined by the first direction X and the second direction Y. The liquid crystalline molecules 32 are positive liquid crystalline molecules having positive dielectric anisotropy.

Unlike the present embodiment, however, the alignment films 12 and 22 may be vertical alignment films that initially align the liquid crystalline monomer and the liquid crystalline molecules 32 along the third direction Z. Alternatively, the liquid crystalline molecules 32 may be negative liquid crystalline molecules having negative dielectric anisotropy.

The liquid crystalline polymer 31 and the liquid crystalline molecules 32 have equivalent optical anisotropy. Alternatively, the liquid crystalline polymer 31 and the liquid crystalline molecules 32 have approximately equivalent refractive anisotropy. In other words, an ordinary refractive index and an extraordinary refractive index of each of the liquid crystalline polymer 31 and the liquid crystalline molecules 32 are approximately equal to each other. Incidentally, for both the ordinary refractive index and the extraordinary refractive index, values of the liquid crystalline polymer 31 and the liquid crystalline molecules 32 may not completely match each other, and a deviation caused by an error in manufacturing or the like is allowed. In addition, the liquid crystalline polymer 31 and the liquid crystalline molecules 32 are different in responsiveness to the electric field. In other words, the responsiveness of the liquid crystalline polymer 31 to the electric field is lower than the responsiveness of the liquid crystalline molecules 32 to the electric field.

The example shown in FIG. 5A corresponds to, for example, a state in which no voltage is applied to the liquid crystal layer 30 (for example, a state in which a potential difference between the pixel electrode 11 and the common electrode 21 is zero) or a state in which a second transparent voltage to be described below is applied to the liquid crystal layer 30.

As shown in FIG. 5A, an optical axis Ax1 of the liquid crystalline polymer 31 and an optical axis Ax2 of the liquid crystalline molecules 32 are parallel to each other. In the example illustrated, each of the optical axis Ax1 and the optical axis Ax2 is parallel to the first direction X. The optical axis corresponds to a line parallel to a direction of travel of the light beam in which the refractive indexes indicate one value irrespective of the direction of polarization.

As described above, since the liquid crystalline polymer 31 and the liquid crystalline molecules 32 have approximately equal refractive anisotropy and the optical axes Ax1 and Ax2 are parallel to each other, a refractive index difference is not substantially made between the liquid crystalline polymer 31 and the liquid crystalline molecules 32 in all directions including the first direction X, the second direction Y, and the third direction Z. For this reason, light beams L1 made incident on the liquid crystal layer 30 in the third direction Z are not substantially scattered in the liquid crystal layer 30 but transmitted. The liquid crystal layer 30 can maintain the parallelism of the light beams L1. Similarly, light beams L2 and L3 made incident in a direction oblique to the third direction Z are not substantially scattered in the liquid crystal layer 30, either. For this reason, high transparency can be obtained. The state illustrated in FIG. 5A is referred to as a “transparent state”.

FIG. 5B is a view schematically showing the liquid crystal layer 30 in a scattered state.

As shown in FIG. 5B, as described above, the responsiveness of the liquid crystalline polymer 31 to the electric field is lower than the responsiveness of the liquid crystalline molecule 32 to the electric field. For this reason, in a state in which a voltage (scattering voltage to be described later) higher than each of the second transparent voltage and a first transparent voltage to be described below is applied to the liquid crystal layer 30, the alignment direction of the liquid crystalline molecules 32 is changed in accordance with the electric field while the alignment direction of the liquid crystalline polymer 31 is hardly changed. In other words, as illustrated in the drawing, the optical axis Ax1 is substantially parallel to the first direction X while the optical axis Ax2 is oblique to the first direction X. For this reason, the optical axis Ax1 and optical axis Ax2 intersect each other.

Therefore, a large refractive index difference is made between the liquid crystalline polymer 31 and the liquid crystalline molecules 32 in all the directions including the first direction X, the second direction Y, and the third direction Z. The light beams L1 to L3 incident on the liquid crystal layer 30 are thereby scattered in the liquid crystal layer 30. The state illustrated in FIG. 5B is referred to as a “scattered state”.

The controller CON switches the state of the liquid crystal layer 30 to at least one of the transparent state and the scattered state.

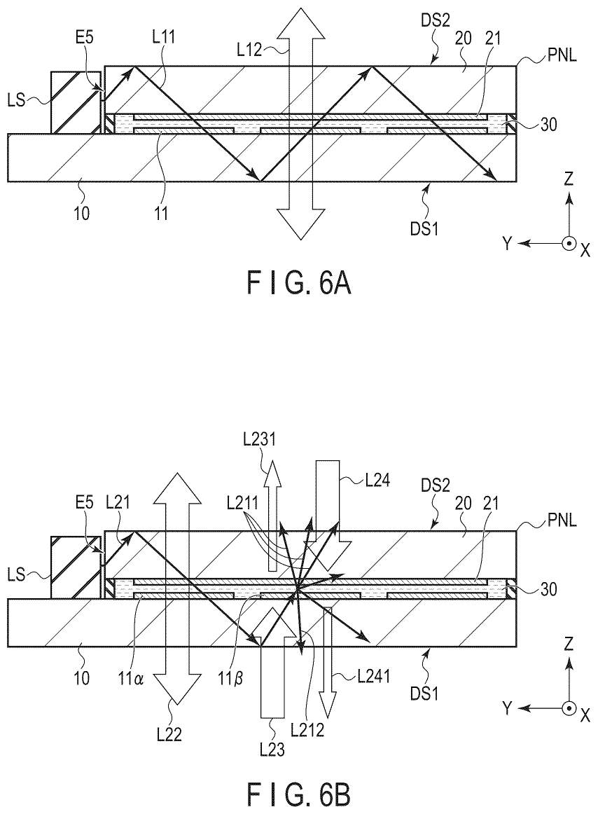

FIG. 6A is a cross-sectional view showing the display panel PNL in a case where the liquid crystal layer 30 is in the transparent state. As shown in FIG. 6A, an illumination light beam L11 emitted from the light emitting element LS is made incident on the display panel PNL from the end portion E5 to propagate through the transparent substrate 20, the liquid crystal layer 30, the transparent substrate 10, and the like. When the liquid crystal layer 30 is in a transparent state, the illumination light beam L11 hardly leaks out from the first display surface DS1 of the transparent substrate 10 and the second display surface DS2 of the transparent substrate 20 since the light beam is hardly scattered by the liquid crystal layer 30.

An external light beam (external light) L12 made incident on the display panel PNL is transmitted and hardly scattered in the liquid crystal layer 30. In other words, the external light made incident on the display panel PNL from the first display surface DS1 is transmitted to the second display surface DS2, and the external light made incident from the second display surface DS2 is transmitted to the first display surface DS1. For this reason, when the display panel PNL is viewed from the second display surface DS2 side, the user can visually recognize the background on the first display surface DS1 side through the display panel PNL. Similarly, when the display panel PNL is viewed from the first display surface DS1 side, the background on the second display surface DS2 side can be visually recognized through the display panel PNL.

FIG. 6B is a cross-sectional view showing the display panel PNL in a case where the liquid crystal layer 30 is in the scattered state. As shown in FIG. 6B, an illumination light beam L21 emitted from the light emitting element LS is made incident on the display panel PNL from the end portion E5 to propagate through the transparent substrate 20, the liquid crystal layer 30, the transparent substrate 10, and the like. In the example illustrated, since the liquid crystal layer 30 between a pixel electrode 11α and the common electrode 21 (i.e., a liquid crystal area to which a voltage applied between the pixel electrode 11α and the common electrode 21 is applied) is in a transparent state, the illumination light beam L21 is hardly scattered in a liquid crystal area opposed to the pixel electrode 11α, in the liquid crystal layer 30. In contrast, since the liquid crystal layer 30 between a pixel electrode 11β and the common electrode 21 (i.e., a liquid crystal area to which a voltage applied between the pixel electrode 11β and the common electrode 21 is applied) is in the scattered state, the illumination light beam L21 is scattered in a liquid crystal area opposed to the pixel electrode 11B, in the liquid crystal layer 30. A scattered light beam L211 of the illumination light beam L21 is emitted from the second display surface DS2 to the outside, and a scattered light beam L212 of the illumination light beam L21 is emitted from the first display surface DS1 to the outside.

At a position overlapping with the pixel electrode 11α, an external light beam L22 made incident on the display panel PNL is transmitted and hardly scattered in the liquid crystal layer 30, similarly to the external light beam L12 shown in FIG. 6A. At the position overlapping with the pixel electrode 11β, an external light beam L23 made incident from the first display surface DS1 is transmitted from the second display surface DS2 after a light beam L231 of the external light beam is scattered by the liquid crystal layer 30. In addition, an external light beam L24 made incident from the second display surface DS2 is transmitted from the first display surface DS1 after a light beam L241 of the external light beam is scattered by the liquid crystal layer 30.

For this reason, a color of the illumination light beam L21 can be visually recognized at a position which overlaps with the pixel electrode 11β when the display panel PNL is observed from the second display surface DS2 side. In addition, since the external light beam L231 is transmitted through the display panel PNL, the background on the first display surface DS1 side can also be visually recognized through the display panel PNL. Similarly, a color of the illumination light beam L21 can be visually recognized at a position which overlaps with the pixel electrode 11β when the display panel PNL is observed from the first display surface DS1 side. In addition, since the external light beam L241 is transmitted through the display panel PNL, the background on the second display surface DS2 side can also be visually recognized through the display panel PNL. At a position overlapping with the pixel electrode 11α, the color of the illumination light beam L21 can hardly be recognized visually and the subject can be captured through the display panel PNL since the liquid crystal layer 30 is in the transparent state.

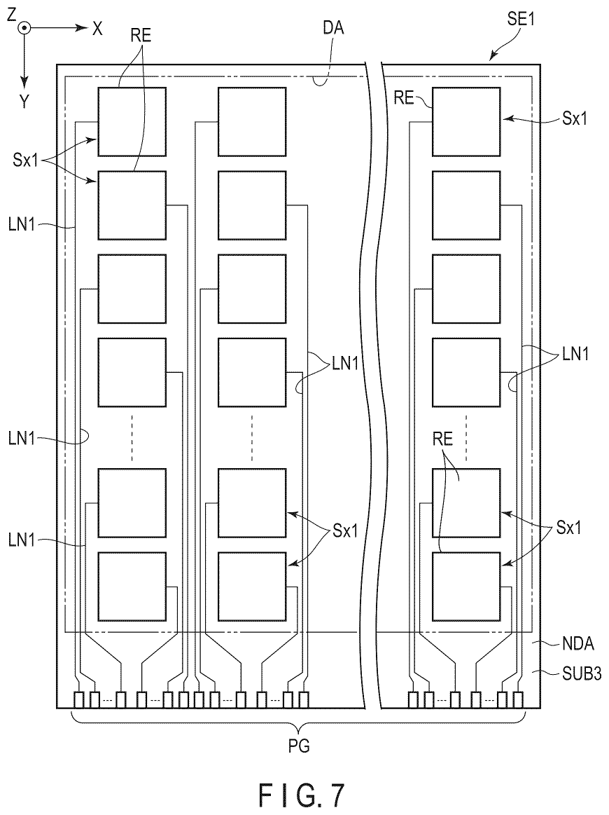

FIG. 7 is a plan view showing a configuration of the sensor SE1 in FIG. 1 and FIG. 3. The sensor SE1 is a sensor which can detect input information and is, for example, a capacitive sensor.

As shown in FIG. 7, the sensor SE1 includes a transparent third substrate SUB3, a plurality of first detection electrodes Sx1, and a plurality of wiring lines LN1. The plurality of first detection electrodes Sx1 are arranged to be opposed to at least the display area DA. The plurality of first detection electrodes Sx1 and the plurality of wiring lines LN1 are provided on the third substrate SUB3. In the present embodiment, a group of the first detection electrodes Sx1 and the wiring lines LN1 is located between the third substrate SUB3 and the display panel PNL. The third substrate SUB3 has the detection surface SS1 shown in FIG. 3.

Unlike the present embodiment, however, the third substrate SUB3 may be located between the group of the first detection electrode Sx1 and the wiring lines LN1, and the display panel PNL. Alternatively, the sensor SE1 may be configured without the third substrate SUB3, and the group of the first detection electrodes Sx1 and the wiring lines LN1 may be provided on the display panel PNL such as the first display surface DS1.

The plurality of first detection electrodes Sx1 are arrayed in a matrix in the first direction X and the second direction Y so as to be electrically independent of each other. In the present embodiment, each first detection electrode Sx1 is formed of a transparent electrode RE. The pixel electrode PE is formed of a transparent conductive material such as ITO or IZO. In the present embodiment, the size of the plurality of transparent electrodes RE is uniform. The first detection electrode Sx1 detects changes in capacitance. However, the first detection electrode Sx1 may be formed by a plurality of detection lines each of which is formed of metal and is a thin wiring line. Alternatively, the first detection electrode Sx1 may be formed by an aggregate of a transparent electrode RE and a plurality of detection lines.

The wiring line LN1 is connected to the first detection electrode Sx1 on a one-to-one basis. The wiring line LN1 is formed of metal. The plurality of wiring lines LN1 are spaced apart from each other and electrically insulated from each other. Although not shown in the drawing, an insulating layer is provided on the first detection electrodes Sx1 and the wiring lines LN1.

In an area which is not opposed to the display area DA of the display panel PNL, a pad group (OLB pad group) PG for outer lead bonding is formed on the third substrate SUB3. The wiring lines LN1 are connected to the pads of the OLB pad group PG on a one-to-one basis. In addition, the above-described wiring board F7 is connected to the pads of the OLB pad group PG. The drive of the plurality of first detection electrodes Sx1 is controlled by the controller CON.

According to the above sensor SE1, handwritten input can be performed.

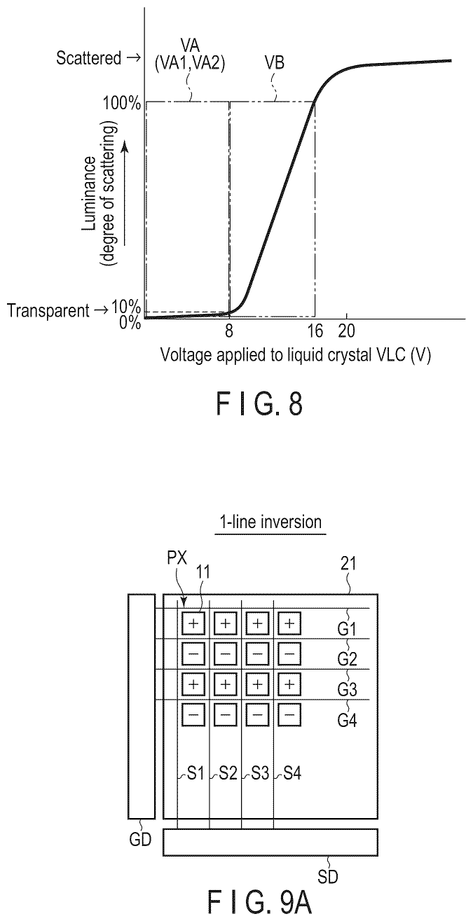

FIG. 8 is a graph showing the scattering characteristic of the liquid crystal layer 30, indicating a relationship between the luminance and a voltage VLC applied to the liquid crystal layer 30. The luminance corresponds to luminance of the scattered light beam L211 (scattered light beam L212) obtained when the illumination light beam L21 emitted from the light emitting element LS is scattered in the liquid crystal layer 30 as shown in, for example, FIG. 6B. This luminance indicates a degree of scattering of the liquid crystal layer 30 from the other viewpoint.

As shown in FIG. 8, when the voltage VLC is increased from 0V, the luminance is rapidly increased from approximately 8V and is saturated at approximately 20V. Incidentally, the luminance is slightly increased even if the voltage VLC is in a range from 0V to 8V. In the present embodiment, the voltage in an area surrounded by a two-dot-chained line, i.e., a range from 8V to 16V is used for reproduction of gradation (for example, 256 gradation) of each pixel PX. The voltage in a range 8V<VLC≤16V is hereinafter referred to as a scattering voltage. In addition, in the present embodiment, the area surrounded by a one-dot-chained line, i.e., the voltage in a range 0V≤VLC≤8V is referred to as a transparent voltage. A transparent voltage VA includes the first transparent voltage VA1 and the second transparent voltage VA2 described above. Incidentally, the lower limit and the upper limit of the scattering voltage VB and the transparent voltage VA are not limited to this example but can arbitrarily be determined in accordance with the scattering property of the liquid crystal layer 30.

The degree of scattering in a case where the degree of scattering of the light made incident on the liquid crystal layer 30 is the highest when the scattering voltage VB is applied to the liquid crystal layer 30 is assumed to be 100%. The degree of scattering in a case of applying the scattering voltage VB of 16V to the liquid crystal layer 30 is assumed to be 100%. For example, the transparent voltage VA can be defied as a voltage in a range of the voltage VLC where the degree of scattering (luminance) is less than 10%. Alternatively, the transparent voltage VA can also be defined as the voltage VLC lower than or equal to a voltage (8V in the example of FIG. 8) corresponding to the lowest gradation.

In addition, the transparent voltage VA (first transparent voltage VA1 and second transparent voltage VA2) may be different from the example shown in FIG. 8. For example, the first transparent voltage VA1 may be a voltage in which the degree of scattering is in a range higher than or equal to 10% and lower than or equal to 50%. In addition, the second transparent voltage VA2 may be a voltage in which the degree of scattering is in a range lower than 10%.

The graph shown in FIG. 8 is applicable to a case where the polarity of the voltage applied to the liquid crystal layer 30 is positive polarity (+) and negative polarity (−). In the latter case, the voltage VLC is an absolute value of the negative-polarity voltage.

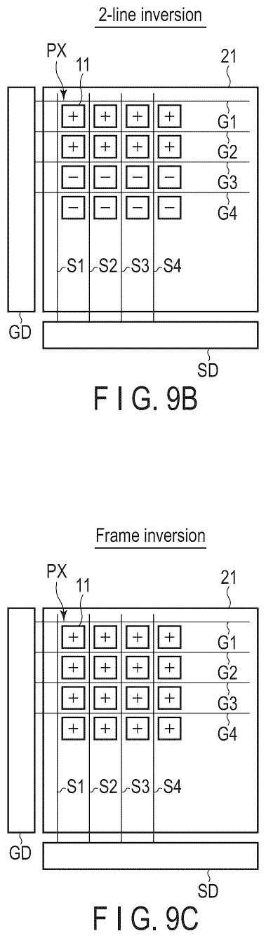

The display device DSP can be applied to polarity inversion drive of inverting the polarity of the voltage applied to the liquid crystal layer 30. FIG. 9A, FIG. 9B, and FIG. 9C are views showing an outline of the polarity inversion drive scheme.

FIG. 9A shows one-line inversion drive scheme of inverting the positive polarity (+) and the negative polarity (−) of the voltage applied to the liquid crystal layer 30 (i.e., the voltage written to the pixel PX) in each group of pixels PX (one line) connected to one gate line G. In such a drive scheme, for example, the polarity of the common voltage supplied to the common electrode 21 and the polarity of the video signal supplied from the source driver SD to the source line S (i.e., polarity of a source line voltage) are inverted for each horizontal period in which the gate driver GD supplies the gate signal to the gate line G. In the same horizontal period, the polarity of the common voltage and the polarity of the video signal are, for example, opposite to each other.

FIG. 9B shows two-line inversion drive scheme of inverting the positive polarity (+) and the negative polarity (−) of the voltage to be applied to the liquid crystal layer 30 in every two lines. The present invention is not limited to the example shown in FIG. 9A and FIG. 9B, but the polarity may be inverted in every three or more lines.

FIG. 9C shows a frame-inversion drive scheme of inverting the voltage applied to the liquid crystal layer 30 to the positive polarity (+) or the negative polarity (−) in each frame period for displaying an image corresponding to one piece of image data. In such a drive method, for example, the polarity of the common voltage and the polarity of the video signal are inverted in each frame period. In the same frame period, for example, the polarity of the common voltage and the polarity of the video signal are opposite to each other. The present invention is not limited to the example shown in FIG. 9C, but the polarity may be inverted in each sub-frame.

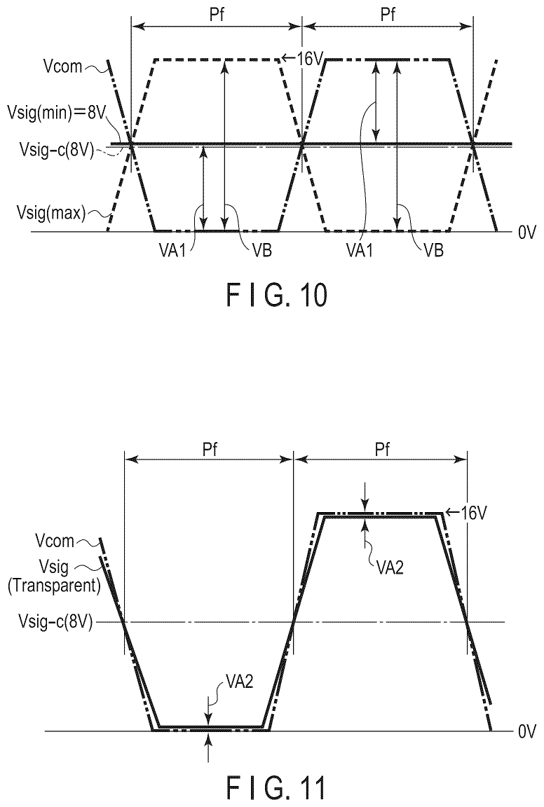

FIG. 10 is a chart showing an example of the common voltage Vcom supplied to the common electrode 21 and the source line voltage Vsig supplied to the source line S (or the pixel electrode 11) in the display drive to which the one-line inversion drive scheme shown in FIG. 9A is applied.

As shown in FIG. 10, a waveform corresponding to a maximum value (max) of gradation and a waveform corresponding to a minimum value (min) of gradation are illustrated with respect to the source line voltage Vsig. The waveform of the source line voltage Vsig (min) is represented by a solid line, the waveform of the common voltage Vcom is represented by a two-dot-chained line, and the waveform of the source line voltage Vsig (max) is represented by a dashed line. In the example of this drawing, the polarities of the common voltage Vcom and the source line voltage Vsig (see the waveform of the maximum value) are inverted in each frame period Pf. Reference voltage Vsig-c is, for example, 8V. The lower limit is 0V and the upper limit is 16V in each of the common voltage Vcom and the source line voltage Vsig.

However, when the frame period Pf includes a plurality of sub-frame periods, the polarity of the common voltage Vcom and the polarity of the source line voltage Vsig may be inverted in each frame period Pf, or may be inverted in each field period (sub-frame period).

The polarity inversion drive scheme including not only the example shown in FIG. 10, but the example of FIG. 11 to be described later will be focused. If the drive voltage to be applied to the liquid crystal layer 30 (voltage to be written to the pixel PX) has positive polarity, a difference (Vsig−Vcom) between the source line voltage Vsig and the common voltage Vcom becomes 0V or a positive voltage value. In contrast, if the drive voltage to be applied to the liquid crystal layer 30 (voltage to be written to the pixel PX) has negative polarity, the difference (Vsig−Vcom) between the source line voltage Vsig and the common voltage Vcom is 0V or a negative voltage value.

The polarity inversion drive scheme shown in FIG. 10 will be focused. In a period in which the positive-polarity voltage is written to the pixel PX, the common voltage Vcom becomes 0V, and the source line voltage Vsig becomes a voltage value corresponding to gradation indicated by image data in a range of 8V or more and 16V or less. In contrast, in a period in which the negative-polarity voltage is written to the pixel PX, the common voltage Vcom becomes 16V, and the source line voltage Vsig becomes a voltage value corresponding to gradation indicated by image data in a range of 0V or more and 8V or less. In other words, in any case, the voltage higher than or equal to 8V and lower than or equal to 16V is applied between the common electrode 21 and the pixel electrode 11.

As shown in FIG. 8, even if the voltage VLC applied to the liquid crystal layer 30 is 8V or the first transparent voltage VA1 is applied to the liquid crystal layer 30, the liquid crystal layer 30 has the degree of scattering of approximately 0 to 10%. Therefore, even if the source line voltage Vsig is the minimum value of the gradation, the external light beam made incident on the display panel PNL may be slightly scattered and the visibility of the background of the display panel PNL may be lowered.

For this reason, as described later, the visibility of the background of the display panel PNL can be improved by applying the transparent drive of making the voltage between the pixel electrode 11 and the common electrode 21 smaller than the lower limit of gradation (i.e., drive in a reset period to be described later) to the sequence of image display.

A relationship between the common voltage Vcom and the output of the source driver SD will be described.

When a withstand voltage of the source driver SD is low, the common voltage Vcom is inversely driven to increase the liquid crystal applied voltage. At this time, the source driver SD can simultaneously output only one of the positive-polarity source line voltage Vsig (for example, reference voltage Vsig-c to 16V) and the negative-polarity source line voltage Vsig (for example, 0V to reference voltage Vsig-c). In addition, the polarity of the common voltage Vcom is opposite to the polarity of the output of the source driver SD.

However, when the source driver SD of a high withstand voltage is used, the relationship between the source line voltage Vsig and the common voltage Vcom may be the same as the above-described relationship but may also be a relationship to be described below. In other words, the common voltage Vcom is fixed to 0V, and the source line voltage Vsig output from the source driver SD is in a range between 0 and +16V at the positive polarity or a range between −16 and 0V at the negative polarity.

FIG. 11 is a chart showing an example of the common voltage Vcom and the source line voltage Vsig in the transparent drive. The waveform of the source line voltage Vsig is represented by a solid line, and the waveform of the common voltage Vcom is represented by a two-dot-chained line.

As shown in FIG. 11, the common voltage Vcom is switched alternately to 0V and 16V in each frame period Pf, similarly to the example shown in FIG. 10. In the transparent drive, the voltage value of the source line voltage Vsig matches the common voltage Vcom (Vsig=Vcom=0V or Vsig=Vcom=16V) in each frame period Pf. In FIG. 11, in view of a relationship in illustration between the source line voltage Vsig and the common voltage Vcom, both are slightly shifted. For this reason, the voltage of 0V is applied to the liquid crystal layer 30. In other words, the second transparent voltage VA2 is applied to the liquid crystal layer 30.

However, the source line voltage Vsig in the transparent drive is not limited to the example shown in FIG. 11. For example, the source line voltage Vsig may be higher than 0V and less than 8V (0V<Vsig<8V) in a period when the common voltage Vcom becomes 0V. The source line voltage Vsig may be higher than 8V and less than 16V (8V<Vsig<16V) in a period when the common voltage Vcom becomes 16V. In either of the cases, according to the transparent drive, an absolute value of the difference between the source line voltage Vsig and the common voltage Vcom is less than 8V and the parallelism of the light transmitted through the liquid crystal layer 30 is increased. In other words, the second transparent voltage VA2 is not limited to 0V but an absolute value of the second transparent voltage VA2 may be less than 8V.

Incidentally, in the transparent drive, the voltage to be applied to the liquid crystal layer 30 may be less than the lower limit (for example, 8V) of the gradation, and the source line voltage Vsig may not completely match the common voltage Vcom. As described above, if the degree of scattering of the light incident on the liquid crystal layer 30 is the highest when the scattering voltage VB is applied to the liquid crystal layer 30, the degree of scattering is assumed to be 100%. It is desirable that, for example, the second transparent voltage VA2 is a voltage in which the degree of scattering is in a range lower than 10%.

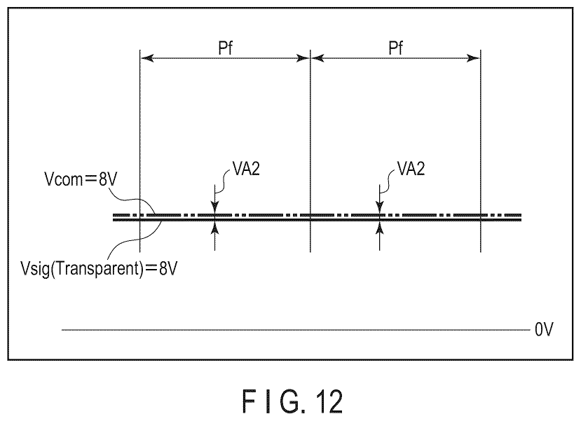

FIG. 12 is a chart showing another example of the common voltage Vcom and the source line voltage Vsig in the transparent drive. The waveform of the source line voltage Vsig is represented by a solid line, and the waveform of the common voltage Vcom is represented by a two-dot-chained line.

As shown in FIG. 12, in this example, the polarity inversion of the common voltage Vcom and the source line voltage Vsig is stopped in the transparent drive. Furthermore, the common voltage Vcom and the source line voltage Vsig match at 8V (above reference voltage Vsig-c). The common voltage Vcom and the source line voltage Vsig may match at a voltage other than the reference voltage Vsig-c, such as 0V. In addition, it is desirable that the second transparent voltage VA2 is a voltage in which the degree of scattering is in a range lower than 10%, similarly to the case shown in FIG. 11.

The one-line inversion drive scheme has been described above as the example of the transparent drive, but similar transparent drive can be applied to a line-inversion drive scheme of two or more lines and a frame inversion drive scheme.

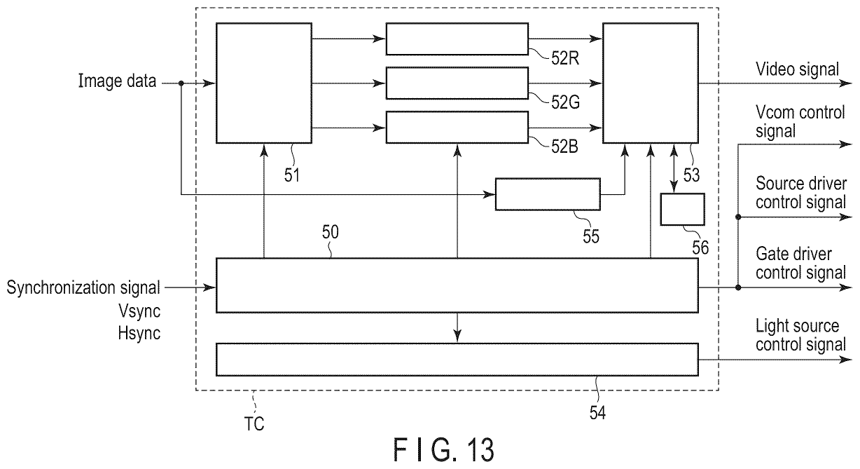

Next, a control example of the electronic device EA incorporating the transparent drive will be described with reference to FIG. 13 to FIG. 18. Incidentally, a drive scheme in which one frame period includes a plurality of sub-frame (field) periods will be applied to the display device DSP. Such a drive scheme is referred to as, for example, field sequential system. Red, green, and blue images are selectively displayed in each of the sub-frame periods. The images of the colors displayed in time division are mixed and visually recognized as multi-color display image by the user.

FIG. 13 is a diagram showing a configuration example of the timing controller TC shown in FIG. 4.

As shown in FIG. 13, the timing controller TC comprises a timing generation unit 50, a frame memory 51, line memories 52R, 52G, and 52B, a data conversion unit 53, a light source control unit 54, a detection unit 55 serving as an address detection unit, and the like.

The frame memory 51 stores image data for one frame input from the outside. The line memories 52R, 52G, and 52B store sub-frame data of red, green, and blue colors, respectively. The sub-frame data represent red, green, and blue images (for example, gradation values of the pixels PX) which the pixels PX are caused to display in time division. The sub-frame data of each of the colors stored in the line memories 52R, 52G, and 52B corresponds to a previous frame of the image data stored in the frame memory 51. The data conversion unit 53 generates a video signal by executing various types of data conversion processing such as gamma correction on the sub-frame data of each color stored in the line memories 52R, 52G, and 52B, and outputs the video signal to the above-described source driver SD. The timing controller TC may be configured to send RGB data to the data conversion unit 53 by allocating the RGB data in the frame memory 51. In this case, the timing controller TC can also be configured without the line memories 52R, 52G, and 52B.

The light source control unit 54 outputs the light source control signal to the above-explained light source driver LSD. The light source driver LSD drives the light emitting elements LSR, LSG, and LSB, based on the light source control signal. The light-emitting elements LSR, LSG, and LSB can be driven under, for example, pulse width modulation (PWM) control. In other words, the light source driver LSD can adjust the luminance of each of the light emitting elements LSR, LSG, and LSB with the duty ratios of the signals output to the light emitting elements LSR, LSG, and LSB.

The timing generation unit 50 controls operation timing of the frame memory 51, the line memories 52R, 52G, and 52B, the data conversion unit 53, and the light source control unit 54 in synchronization with a vertical synchronization signal Vsync and a horizontal synchronization signal Hsync which are input from the outside. In addition, the timing generation unit 50 controls the source driver SD by outputting a source driver control signal, controls the gate driver GD by outputting a gate driver control signal, and outputs a Vcom control signal.

The detection unit 55 is configured, when image data for one frame input from the outside includes data of an image, to detect an address of the data of the image. Examples of the image include a character displayed in a part of the display area DA, and the like. Examples of the character include a symbol including a letter, a figure, an icon, and the like. In addition, a case where data of the character is included in the image data means a case where data other than 0 is included in at least one piece of all bits of digital data. Address information of the data of the image is supplied to the data conversion unit 53. For this reason, when the image data input from the outside includes the data of the image, the timing controller TC can generate the processed video signal and output the processed video signal to the source driver SD in order to adjust the degree of scattering (transparency) of an area other than the area where the image is displayed. Generation of the processed video signal can be executed by calculation of the data conversion unit 53 or can be executed by using data stored in a table 56 of the timing controller TC.

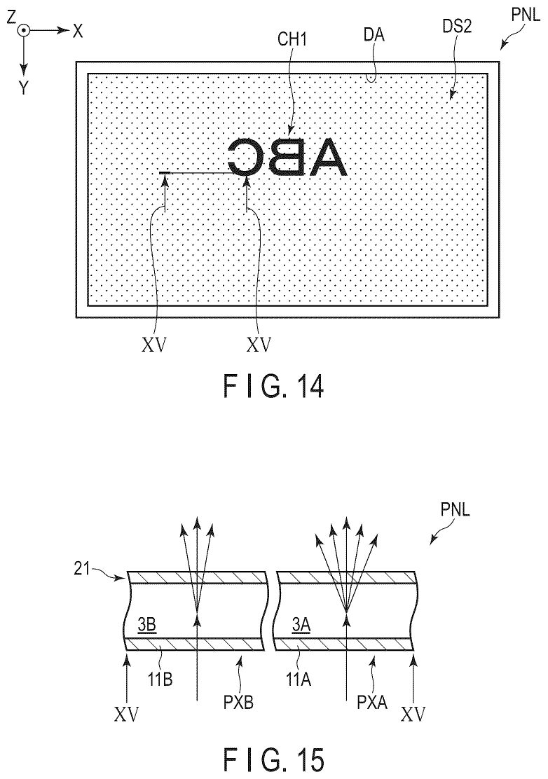

An example of displaying a first character CH1 input by the teacher, in the display area DA of the display panel PNL, will be described. FIG. 14 is a plan view showing the display panel PNL from a second display surface DS2 side, illustrating an example of use of the electronic device EA, and a state in which a teacher inputs a character in a sensor SE1, a scattering voltage VB and a first transparent voltage VA1 are applied to the liquid crystal layer 30, and the first character CH1 is displayed in the display area DA of the display panel PNL.

It is assumed that as shown in FIG. 14, a teacher in front of the first display surface DS1 inputs the character string “ABC” to the sensor SE1, during the first period. During the first period, the controller CON generates the first image data based on the input information detected by the sensor SE1, stores the above first image data in the memory unit ME, and displays the first character CH1 based on the above first image data stored in the memory unit ME, in the display area DA of the display panel PNL.

The first character CH1 is a flipped character string “ABC”. In plan view, the character string “ABC” of the first character CH1 displayed in the display area DA (i.e., the flipped character string “ABC”) overlaps with the character string “ABC” input to the sensor SE1 by the teacher.

The scattering voltage VB higher than or equal to a predetermined voltage of a gradation voltage is applied to each pixel in an area overlapping with the first character CH1. In addition, in this example, the first transparent voltage VA1 is supplied to each pixel in an area which does not overlap with the first character CH1. Incidentally, the above first transparent voltage VA1 is a voltage in a predetermined range in the vicinity where the gradation reproduction of the gradation voltage can be executed.

Since the first character CH1 is displayed in front of the second display surface DS2 as the flipped character string “ABC”, students in front of the second display surface DS2 can hardly identify (i.e., hardly read) the first character CH1.

FIG. 15 is a cross-sectional view showing the display panel PNL of FIG. 14 along line XV-XV. FIG. 15 illustrates only parts of the display panel PNL necessary for description. In addition, FIG. 15 illustrates an optical path, and also illustrates a scene where light is diffused by the liquid crystal layer 30 and a scene where the parallelism of light is maintained by the liquid crystal layer 30.

As shown in FIG. 15, the plurality of pixels PX of the display panel PNL include a first pixel PXA and a second pixel PXB. The first pixel PXA includes a first pixel electrode 11A, and the second pixel PXB includes a second pixel electrode 11B.

The liquid crystal layer 30 (display function layer) includes a plurality of liquid crystal areas 3 (display function areas). The liquid crystal layer 30 includes a first liquid crystal area 3A (first display function area) where a voltage applied between the first pixel electrode 11A and the common electrode 21 is applied, and a second liquid crystal area 3B (second display function area) where a voltage applied between the second pixel electrode 11B and the common electrode 21 is applied. In the present embodiment, the first liquid crystal area 3A is sandwiched between the first pixel electrode 11A and the common electrode 21, and the second liquid crystal area 3B is sandwiched between the second pixel electrode 11B and the common electrode 21.

A voltage is applied between one corresponding pixel electrode 11 of the plurality of pixel electrodes 11 and the common electrode 21, and the scattering voltage VB and the transparent voltage (first transparent voltage VA1) are thus selectively applied to each of the liquid crystal areas 3 (display function areas). Each of the liquid crystal areas 3 (display function areas) is switched to a transparent state in which incident light is transmitted and a scattered state in which incident light is scattered by the voltage applied between the corresponding pixel electrode 11 among the plurality of pixel electrodes 11 and the common electrode 21.

The liquid crystal layer 30 (liquid crystal area 3) maintains the parallelism of light made incident when the first transparent voltage VA1 is applied. The parallelism of the external light beam transmitted through each of the liquid crystal areas 3 when the transparent voltage (first transparent voltage VA1) is applied is higher than the parallelism of the external light beam transmitted through each of the liquid crystal areas 3 when the scattering voltage VB is applied. In addition, the degree of scattering of the external light beam transmitted through the liquid crystal area 3 when the scattering voltage VB is applied is higher than the degree of scattering of the external light beam transmitted through the liquid crystal area 3 when the transparent voltage (first transparent voltage VA1) is applied.

As shown in FIG. 14 and FIG. 15, the first pixel PXA is located in the area overlapping with the first character CH1, and the scattering voltage VB is supplied to the first liquid crystal area 3A, in a period in which the first character CH1 is displayed. In contrast, the second pixel PXB is located in the area which does not overlap with the first character CH1, and the first transparent voltage VA1 is supplied to the second liquid crystal area 3B. In the present embodiment, since the liquid crystal layer 30 uses a reverse mode polymer dispersed liquid crystal, the scattering voltage VB is higher than the first transparent voltage VA1. Unlike the present embodiment, however, when the liquid crystal layer 30 uses a normal mode polymer dispersed liquid crystal, the first transparent voltage VA1 is higher than the scattering voltage VB.

One frame period of the period in which the first character CH1 is displayed in the display area DA will be focused. The controller CON applies a voltage between each of the plurality of pixel electrodes 11 and the common electrode 21 in a write period, selectively applies the scattering voltage VB and the transparent voltage (first transparent voltage VA1) to the plurality of liquid crystal areas 3, and prohibits the light emission executed by the light source unit LU.

The controller CON holds a state in which the scattering voltage VB and the transparent voltage (first transparent voltage VA1) are selectively applied to the plurality of liquid crystal areas 3 in a light emission period which is independent of the write period and subsequent to the write period, permits the light emission executed by the light source unit LU, emits light to the liquid crystal layer 30, and scatters the light emitted by the light source unit LU in the plurality of liquid crystal areas 3 to which the scattering voltage VB is applied, among the plurality of liquid crystal areas 3. As a result, the controller CON can display the first character CH1 in the display area DA.

The color of the first character CH1 displayed in the display area DA (for example, the color of the first pixel PXA) is based on the color emitted by the light source unit LU. For this reason, the controller CON can set the color of the first character CH1 to a single color emitted by the light source unit LU or a color mixture of a plurality of colors emitted by the light source unit LU. In addition, it is also possible to display the entire first character CH1 in a single color or display the first character CH1 in different colors for each part.

A degree of scattering of light in the first liquid crystal area 3A is higher than a degree of scattering of light in the second liquid crystal area 3B. The first liquid crystal area 3A becomes a scattered state. For this reason, when the background is viewed through the display panel PNL, the visibility of the background can most degrade in the area which overlaps with the first character CH1.

In contrast, the parallelism of light passing through the second liquid crystal area 3B is higher than the parallelism of light passing through the first liquid crystal area 3A. The second liquid crystal area 3B becomes a first transparent state. Light is slightly scattered in the second liquid crystal area 3B.

When viewing the background through the display panel PNL, the background can be blurred in the area which does not overlap with the first character CH1, the visibility of the background in the area which does not overlap with the first character CH1 can be reduced, and students can thereby easily identify the first character CH1.

Unlike the present embodiment, a second transparent voltage may be applied to the second liquid crystal area 3B, and the second liquid crystal area 3B may be in a second transparent state. Since the parallelism of the light passing through the second liquid crystal area 3B can be increased, the teacher and the student can easily make eye contact with a counterpart and confirm the counterpart's gesture through the display panel PNL.

During the second period following the above-described first period, the controller CON generates the second image data based on the first image data stored in the memory unit ME, and records the second image data in the memory unit ME.

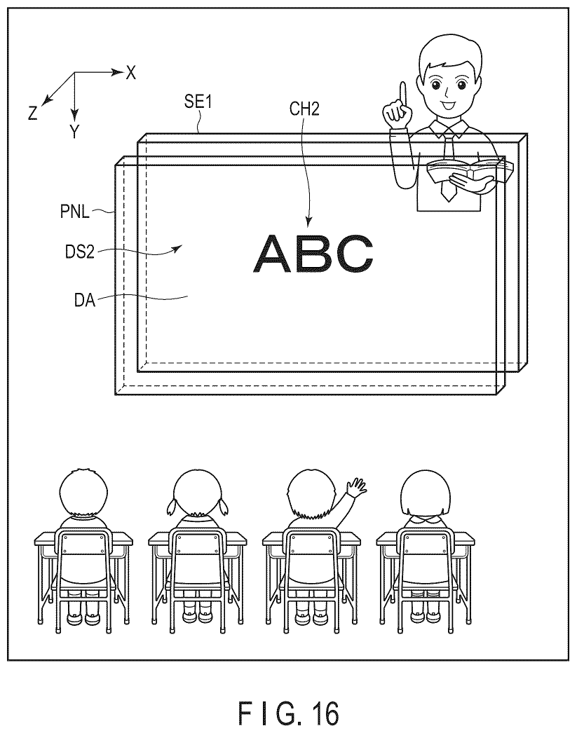

FIG. 16 is an exploded perspective view showing a part of the electronic device EA of the first embodiment, showing the display panel PNL and the sensor SE1 from the second display surface DS2 side, and illustrating a state in which the character input by the teacher is flipped in the display area DA of the display panel PNL and the teacher faces the students through the display panel PNL and the sensor SE1.

As shown in FIG. 16, the controller CON displays the second character CH2 based on the above second image data, instead of the first character CH1, in the display area DA of the display panel PNL, during a third period following the second period. The second character CH2 is a character obtained by horizontally flipping the first character CH1.

The first character CH1 displayed in front of the first display surface DS1 during the first period and the second character CH2 displayed in front of the second display surface DS2 during the third period are, for example, similar to each other. In the present embodiment, the first character CH1 and the second character CH2 are the same as each other, but the size of the second character CH2 can be adjusted variously. For example, the size of the second character CH2 may be larger than that of the first character CH1.

Since the second character CH2 is displayed in front of the second display surface DS2 as the character string “ABC”, the students in front of the second display surface DS2 can easily identify (read) the second character CH2. The problem that students always see the first character CH1 (horizontally flipped character) can be solved.

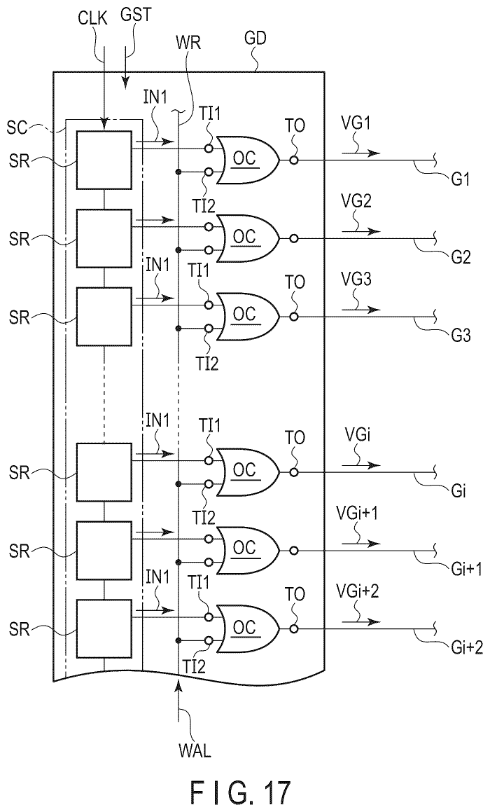

Next, the gate driver GD of the present embodiment will be described. FIG. 17 is a circuit diagram showing parts of the gate driver GD and several gate lines G shown in FIG. 4 and the like.

As shown in FIG. 17, the gate driver GD comprises a sequential circuit SC, a control line WR, and a plurality of OR circuits OC. The sequential circuit SC includes a plurality of shift registers SR. The plurality of shift registers SR are connected in series.

The OR circuits OC are connected to the shift registers SR on a one-to-one basis. The OR circuit OC includes a first input terminal TI1, a second input terminal TI2, and an output terminal TO. The first input terminal TI1 is connected to the corresponding shift register SR. The second input terminal TI2 is connected to the control line WR. The output terminal TO is connected to one corresponding gate line G.

When a high-level first input signal IN1 is supplied from the shift register SR to the first input terminal TI1, the OR circuit OC outputs a first-level gate signal VG from the output terminal TO to the gate line G. When a high-level second input signal WAL is supplied from the control line WR to the second input terminal TI2, the OR circuit OC outputs the first-level gate signal VG from the output terminal TO to the gate line G. In addition, when a low-level first input signal IN1 and a low-level second input signal WAL are simultaneously supplied, the OR circuit OC outputs a second-level gate signal VG from the output terminal TO to the gate line G. For example, the first level is a high level, and the second level is a low level.

The controller CON (for example, the timing controller TC) supplies the high-level second input signal WAL to the control line WR, and the gate driver GD thereby simultaneously outputs the first-level gate signal VG to all the gate lines G. As a result, all the switching elements SW can be turned on at once.

Alternatively, the controller CON (for example, the timing controller TC) supplies the low-level second input signal WAL to the control line WR. The sequential circuit SC sequentially supplies the high-level first input signal IN1 to the first input terminals TI1 of all the OR circuits OC. The gate driver GD sequentially outputs the first-level gate signal VG to all the gate lines G, and turns on the switching elements SW.

Unlike the present embodiment, however, the gate driver GD may not be configured to simultaneously output the first-level gate signal VG to all the gate lines G. For example, the gate driver GD may be configured to repeatedly execute the operation of simultaneously outputting the first-level gate signal VG to the plurality of gate lines G of the plurality of rows while changing a target to which the first-level gate signal VG is output.

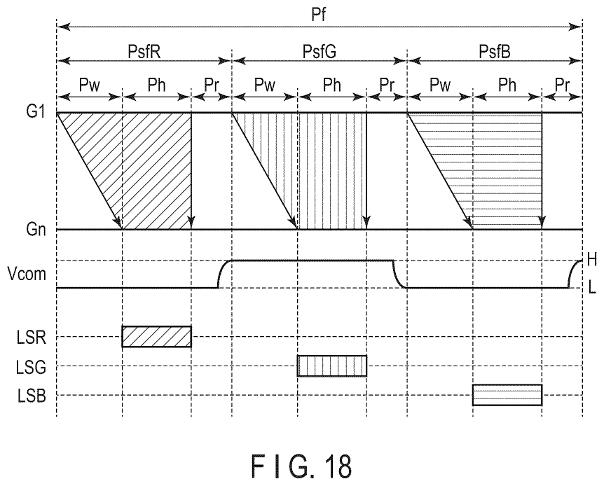

FIG. 18 is a timing chart for illustrating an example of an operation of the electronic device EA according to the first embodiment. As shown in FIG. 18, one frame period Pf corresponds to, for example, a period from the time when the vertical synchronization signal Vsync falls to the time when the vertical synchronization signal falls again. For example, if the display device DSP is driven at 60 Hz, one frame period Pf is approximately 16.7 ms.

One frame period Pf includes a first sub-frame period PsfR, a second sub-frame period PsfG, and a third sub-frame period PsfB, which are independent of each other. In this example, the first sub-frame period PsfR, the second sub-frame period PsfG, and the third sub-frame period PsfB are continued in this order. Unlike the present embodiment, however, the order of these sub-frame periods Psf may be changed. Each of the first sub-frame period PsfR, the second sub-frame period PsfG, and the third sub-frame period PsfB includes a write period Pw and a light emission period Ph subsequent to the write period Pw.

At least one sub-frame period Psf of the first sub-frame period PsfR, the second sub-frame period PsfG, and the third sub-frame period PsfB further includes a reset period Pr. In the present embodiment, each of the first sub-frame period PsfR, the second sub-frame period PsfG, and the third sub-frame period PsfB includes the reset period Pr. The reset period Pris independent of the write period Pw and the light emission period Ph and is subsequent to the light emission period Ph. Unlike the present embodiment, however, the reset period Pr may precede the write period Pw.

In each sub-frame period Psf, the timing generation unit 50 executes display drive of each color by controlling the frame memory 51, the line memories 52R, 52G, and 52B, and the data conversion unit 53 by a data synchronization signal SS or using the detection unit 55 and the table 56.

In the write period Pw of the first sub-frame period PsfR, the gate driver GD sequentially supplies the high-level gate signal VG to each of the gate lines G1 to Gn. Furthermore, while the gate signal is supplied, the source driver SD supplies the source line voltage Vsig corresponding to red sub-frame data (R_DATA) stored in line memory 52R to each of the source lines S1 to Sm. More specifically, an operation of simultaneously supplying the source line voltage Vsig of the gradation corresponding to each pixel PX of the line to which the gate signal is supplied to each of the source lines S1 to Sm is repeated. The electric potential of the pixel electrode 11 is held by supplying the source line voltage Vsig to the pixel electrode 11 of the pixel PX corresponding to the selected gate line G via the switching element SW and then switching the switching element SW to a non-conductive state. After that, the gate line G of a subsequent row is selected and the same drive is sequentially executed. Incidentally, in this example, the polarity of the common voltage Vcom for driving the common electrode 21 is inverted in each sub-frame period Psf. More specifically, the polarity of the common voltage Vcom is inverted after the timing at which writing the second transparent voltage VA2 to all the pixels PX is ended, in the reset period Pr.

The voltage corresponding to the red sub-frame data is applied between the pixel electrode 11 of each of the pixels PX and the common electrode 21 by this operation. In each sub-frame period Psf, the source line voltage Vsig supplied to each pixel electrode 11 via each of the source lines S1 to Sm has polarity different from that of the common voltage Vcom of the common electrode 21 or is the reference voltage Vsig-c. Accordingly, an absolute value of the voltage written to each of the pixels PX in the display area DA is 8V or more and 16V or less. Based on the above, the controller CON selectively applies the scattering voltage VB and the first transparent voltage VA1 to the plurality of liquid crystal areas 3 in the write period Pw.

The light emission period Ph of the first sub-frame period PsfR is a period from the completion of writing to all the pixels PX to the arrival of the reset period Pr. In the light emission period Ph, the controller CON holds a state in which the scattering voltage VB and the first transparent voltage VA1 are selectively applied to the plurality of liquid crystal areas 3, permits the light emitting element LSR to emit light of the first color, prohibits the light emitting element LSG to emit light of the second color, and prohibits the light emitting element LSB to emit light of the third color.

As a result, the controller CON can scatter the light of the first color emitted by the light emitting element LSR in the plurality of liquid crystal areas 3 to which the scattering voltage VB is applied in the write period Pw of the first sub-frame period PsfR. Then, a red image is thereby displayed in the display area DA.

Incidentally, when the light emitting element LSR is turned on, the light emitting element is turned on without a margin period after the writing to all the pixels PX is completed. Unlike the present embodiment, however, the light emitting element LSR may be turned on with the margin period after the writing to all the pixels PX is completed. As a result, for example, a response period of the liquid crystal can be secured.

In the reset period Pr of the first sub-frame period PsfR, the transparent drive is executed under control of the timing controller TC. In other words, the gate driver GD simultaneously supplies the high-level gate signal VG to each of the gate lines G1 to Gn. For example, the transparent drive can be executed by supplying the high-level second input signal WAL to the control line WR. Furthermore, the source driver SD supplies, for example, the source line voltage Vsig having the same value as the common voltage Vcom to each of the source lines S1 to Sm while supplying the gate signal VG. By such an operation, the second transparent voltage VA2 is applied to the plurality of liquid crystal areas 3.

After the gate signal VG is supplied to the corresponding gate line G, the pixel electrode 11 of each pixel PX becomes in an electrically floating state until the gate signal VG is supplied to the gate line G next time. Therefore, in the pixel PX (liquid crystal area 3) to which the second transparent voltage VA2 is written, the second transparent voltage VA2 is held until a next gate signal VG is supplied to the corresponding gate line G.

In the pixel PX to which the second transparent voltage VA2 is written, the liquid crystal area 3 is in a good second transparent state. In the reset period Pr, all of the light emitting elements LSR, LSG, and LSB are turned off. Incidentally, the light-emitting elements LSR, LSG, and LSB are desirably turned off in the reset period Pr but may be turned on in the reset period Pr.

The source line voltage Vsig supplied to each of the source lines S1 to Sm in the reset period Pr does not need to be the same as the common voltage Vcom as long as the voltage written to each pixel PX is a value which becomes the second transparent voltage VA2. Various aspects described with reference to FIG. 11 and FIG. 12 can be applied to the common voltage Vcom and the source line voltage Vsig in the transparent drive.

By securing a period for collectively supplying the high-level gate signal VG to all the gate lines G1 to Gn in the reset period Pr, for a certain period, the electric potential of the pixel electrode 11 and the electric potential of the common electrode 21 can be caused to transition to desired values. In addition, in the example illustrated, the reset period Pr includes a holding period for holding the second transparent voltage VA2 after the second transparent voltage VA2 is applied to all the liquid crystal areas 3. Unlike the present embodiment, however, the reset period Pr may be a period in which the second transparent voltage VA2 is applied to all the liquid crystal areas 3, and the reset period Pr may not include the above holding period.

The operation in the second sub-frame period PsfG and the third sub-frame period PsfB is the same as that in the first sub-frame period PsfR. In other words, the second sub-frame period PsfG includes the write period Pw, the light emission period Ph, and the reset period Pr, and a voltage corresponding to green sub-frame data (G_DATA) stored in the line memory 52G is written to the pixel PX in the display area DA, in the write period Pw.

In the light emission period Ph of the second sub-frame period PsfG, the controller CON holds a state in which the scattering voltage VB and the first transparent voltage VA1 are selectively applied to the plurality of liquid crystal areas 3, permits the light emitting element LSG to emit light of the second color, prohibits the light emitting element LSR to emit light of the first color, and prohibits the light emitting element LSB to emit light of the third color.

As a result, the controller CON can scatter the light of the second color emitted by the light emitting element LSG in the plurality of liquid crystal areas 3 to which the scattering voltage VB is applied in the write period Pw of the second sub-frame period PsfG. Then, a green image is thereby displayed in the display area DA.

In addition, the third sub-frame period PsfB includes the write period Pw, the light emission period Ph, and the reset period Pr, and a voltage corresponding to blue sub-frame data (B_DATA) stored in the line memory 52B is written to the pixel PX in the display area DA, in the write period Pw.

In the light emission period Ph of the third sub-frame period PsfB, the controller CON holds a state where the scattering voltage VB and the first transparent voltage VA1 are selectively applied to the plurality of liquid crystal areas 3, permits the light emitting element LSB to emit light of the third color, prohibits the light emitting element LSR to emit light of the first color, and prohibits the light emitting element LSG to emit light of the second color.

As a result, the controller CON can scatter the light of the third color emitted by the light emitting element LSB in the plurality of liquid crystal areas 3 to which the scattering voltage VB is applied in the write period Pw of the third sub-frame period PsfB. Then, a blue image is thereby displayed in the display area DA.

In a certain frame period Pf, image data displayed in the subsequent frame period Pf are written to the frame memory 51. Furthermore, the sub-frame data of the line memories 52R, 52G, and 52B by which writing to the pixels PX are rewritten to sub-frame data corresponding to the image data written to the frame memory 51.

The multi-color display image (e.g., a character) is visually recognized for the user by mixing red, green, and blue images displayed in time division in the first sub-frame period PsfR, the second sub-frame period PsfG, and the third sub-frame period PsfB.

In addition, in the reset period Pr, the second transparent voltage VA2 is applied to each of the liquid crystal areas 3. A period in which the transparency of the display area DA increases can be increased by setting such a reset period Pr once in each sub-frame period Psf. Incidentally, the reset period Pr may be provided once in each frame period Pf or may be provided once in a plurality of frame periods. From a viewpoint of suppressing display failures such as burning of an image, a frequency of resetting is preferably high.

The transparency of the display area DA of the display panel PNL can be improved by incorporating transparent drive (i.e., drive to make the voltage between the pixel electrode 11 and the common electrode 21 smaller than, for example, the lower limit of the gradation) in the reset period into the image display sequence. For example, the teacher and students can easily communicate with each other.

When the reset period Pr is adjusted, not only the period until the potential of the pixel electrode 11 and the potential of the common electrode 21 transition to desired values as described above, but also the transparency of the display area DA may be considered.

As the rate of the reset period Pr to the frame period Pf becomes larger, the transparency of the display area DA is increased but the image visibility may be reduced. The length of the reset period Pr is desirably determined by considering these matters.

For example, the first sub-frame period PsfR, the second sub-frame period PsfG, and the third sub-frame period PsfB can be set to have the same length. The color chromaticity of the display image may be adjusted by differentiating the proportion of the first sub-frame period PsfR, the second sub-frame period PsfG, and the third sub-frame period PsfB.

The scattering voltage VB and the first transparent voltage VA1 in consideration of the polarity inversion drive scheme will be described here.

As shown in FIG. 8, FIG. 9A, FIG. 9B, and FIG. 9C, the scattering voltage VB has a positive-polarity scattering voltage and a negative-polarity scattering voltage. The positive-polarity scattering voltage is, for example, 8V to 16V, and the negative-polarity scattering voltage is, for example, −16 to −8V.

Absolute values of the positive-polarity first transparent voltage VA1 and the negative-polarity first transparent voltage VA1 are a half of a maximum value of the positive-polarity scattering voltage VB and a half of a maximum value of the absolute value of the negative-polarity scattering voltage VB, respectively. For example, in the example shown in FIG. 10, each of the positive-polarity first transparent voltage VA1 and the absolute value of the negative-polarity first transparent voltage VA1 is 8V, and each of the maximum value of the positive-polarity scattering voltage VB and the maximum value of the absolute value of the negative-polarity scattering voltage VB is 16V. For example, even if the first transparent voltage VA1 and the scattering voltage VB have any polarity, the absolute value of the first transparent voltage VA1 is half the maximum value of the absolute value of the scattering voltage VB. However, the present invention is not limited to the above example, but the positive-polarity and negative-polarity first transparent voltages VA1 may be voltages whose degree of scattering is in a range of 50% or less.

The timing of flipping from the first character CH1 to the second character CH2 with respect to the image to be displayed in the display area DA will be described.

The controller CON can display the second character CH2 in the display area DA after a specific period of time from the timing when obtaining the input information by the sensor SE1 is ended. For example, when determining that the sensor SE1 has not obtained the next input information for several seconds after the timing when the sensor SE1 last obtained the input information, the controller CON can display the second character CH2 in the display area DA. By setting (registering) the timing of flipping the character to the controller CON in advance, the controller CON can automatically flip the character without performing any operation by the teacher.

Alternatively, the electronic device EA may use a determination unit JU. The determination unit JU can detect a flip signal transmitted by the input by the user. For example, the determination unit JU can detect a flip signal transmitted from the sensor SE1 by the teacher's input to the sensor SE1.

Incidentally, the teacher may transmit the flip signal to the determination unit JU by using an input meams other than sensor SE1. For example, when the teacher determines that inputting the character to the sensor SE1 using a stylus serving as an input device has been ended, the teacher can transmit the flip signal from the stylus to the determination unit JU by wireless communication by pressing a switch on the stylus.

When the determination unit JU determines that the flip signal has been detected, the controller CON can display the second character CH2 in the display area DA. For example, since the teacher can manually control the timing for flipping the character, the character can be flipped at the desired timing.

According to the electronic device EA of the first embodiment configured as

described above, the electronic device EA comprises a display panel PNL, a first sensor SE1, a memory unit ME, and a controller CON.

During the first period, the controller CON generates the first image data based on the input information detected by the sensor SE1, stores the above first image data in the memory unit ME, and displays the first character CH1 based on the above first image data stored in the memory unit ME, in the display area DA of the display panel PNL. During the second period following the above-described first period, the controller CON generates the second image data based on the first image data stored in the memory unit ME, and records the second image data in the memory unit ME. During the third period following the second period, the controller CON displays the second character CH2 based on the above second image data, in the display area DA of the display panel PNL instead of the first character CH1. The second character CH2 is a character obtained by flipping the first character CH1.

For example, when the teacher turns to the student and inputs (fills in) the first character CH1, the teacher can show the second character CH2 obtained by horizontally flipping the first character CH1 to the students, and the students can thereby easily identify the character input by the teacher. The teacher does not turn his/her back to the students when using the electronic device EA. The teacher and the students can face each other through the display area DA of the electronic device EA, and the teacher and the students can look at each other. The teacher can also input the first character CH1 while looking at the students. Therefore, the quality of communication between the teacher and the students can be improved. In addition, both the teacher and the students can easily share the recognition that the teacher faces the students.

The image displayed in the display area DA of the electronic device EA may be not only a character manually input by the teacher, but also a map, chart, or other image. For example, the electronic device EA can display both a map and a character in the display area DA. For example, the teacher can input characters (write letters) while pointing to the map or the like, and can instantly recognize the students' responses. The teacher can therefore change the expression or immediately rephrase the expression. Based on the above, the electronic device EA capable of improving the quality of communication can be obtained.

The gate driver GD can output the high-level (on-level) gate signal VG to all the gate lines G in the reset period Pr at once. For this reason, the period of the reset period Pr can be reduced as compared with the case of sequentially scanning the gate lines G in the reset period Pr.

In addition, according to the configuration of the present embodiment, the display device DSP can be driven by the source driver SD of a low withstand voltage. This advantage will be described with reference to FIG. 8 and FIG. 10.

A comparative example in which the common voltage Vcom is a DC voltage and the only polarity of the source line voltage Vsig is inversed about the common voltage Vcom is assumed. In this case, a voltage of 0V (second transparent voltage VA2) can be applied to each liquid crystal area 3 even in normal display drive, by setting the source line voltage Vsig to the same voltage as the common voltage Vcom. In this comparative example, however, the source line voltage Vsig needs be variable within a range between −16V and +16V to the common voltage Vcom to use the scattering voltage shown in FIG. 7 for the gradation expression. In other words, the circuit such as the source driver SD needs to have the withstand voltage of 32V.

In contrast, according to the constitution of the present embodiment, the source line voltage Vsig and the common voltage Vcom may be variable within a range of, for example, 16V as shown in FIG. 10. In other words, the circuit such as the source driver SD needs only to have the withstand voltage of 16V. Thus, the circuit size and the manufacturing costs can be reduced by suppressing the withstand voltage of the circuit.

In addition to the above, various suitable advantages can be obtained from the present embodiment.

### Second Embodiment

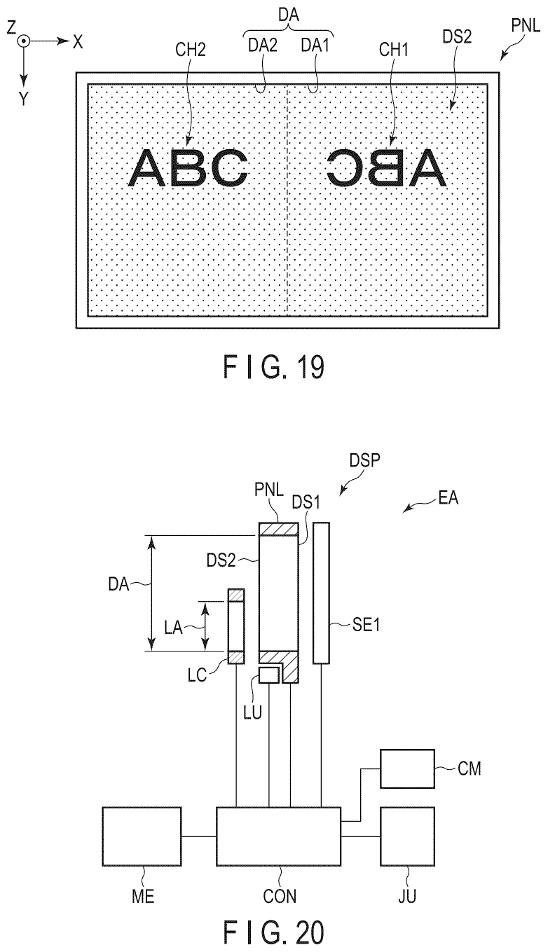

Next, a second embodiment will be described. An electronic device EA of the second embodiment is configured similarly to the above-described electronic device EA of the first embodiment. FIG. 19 is a plan view showing the display panel PNL from the second display surface DS2 side in the electronic device EA according to the second embodiment, illustrating an example of the use of the electronic device EA, and a state in which the first character CH1 input to the sensor SE1 by the teacher is displayed in the first display area DA1 and the first character CH1 input by the teacher is flipped in the second display area DA2.

As shown in FIG. 19, the display area DA of the display panel PNL includes a first display area DA1 and a second display area DA2.

The controller CON generates the first image data based on the input information detected by the sensor SE1 in the first display area DA1, stores the above first image data in the memory unit ME, and displays the first character CH1 based on the above first image data stored in the memory unit ME, in the first display area DA1 of the display panel PNL. The controller CON generates the second image data based on the first image data stored in the memory unit ME, and records the second image data in the memory unit ME. The controller CON displays a second character CH2 based on the second image data, in the second display area DA2 of the display panel PNL.

The second character CH2 is a character obtained by horizontally flipping the first character CH1. The first character CH1 displayed in front of the first display surface DS1 and the second character CH2 displayed in front of the second display surface DS2 are, for example, similar to each other.

The first character CH1 in the first display area DA1 is displayed in front of the first display surface DS1 as a character string “ABC”, and the second character CH2 in the second display area DA2 is displayed in front of the second display surface DS2 as a character string “ABC”. For this reason, the teacher in front of the first display surface DS1 can easily identify the first character CH1, and the students in front of the second display surface DS2 can easily identify the second character CH2, during the same period of time.

The same advantages as those of the above-described first embodiment can also be obtained from the electronic device EA of the second embodiment configured as described above. The above character can be flipped and displayed in the second display area DA2 while displaying the character in the first display area DA1. The display area DA of the electronic device EA can be divided into a plurality of areas. For example, as described above, the display area DA of the electronic device EA can be divided into the first display area DAI for the teacher and the second display area DA2 for the students.

### Third Embodiment

Next, a third embodiment will be described. An electronic device EA is configured similarly to the electronic device EA of the first embodiment except for a configuration to be described in the third embodiment. FIG. 20 is a block diagram showing an electronic device EA according to the third embodiment, using functional blocks.

As shown in FIG. 20, the electronic device EA further comprises a light control panel LC. A controller CON is connected to the light control panel LC and can control the drive of the light control panel LC. The light control panel LC faces the second display surface DS2 of the display panel PNL and overlaps with the light control area LA, which is at least a part of the display area DA. The light control panel LC can be switched between a transmissive state in which light made incident from the light control area LA side of the second display surface DS2 is transmitted and a light-shielding state in which the above light is blocked.

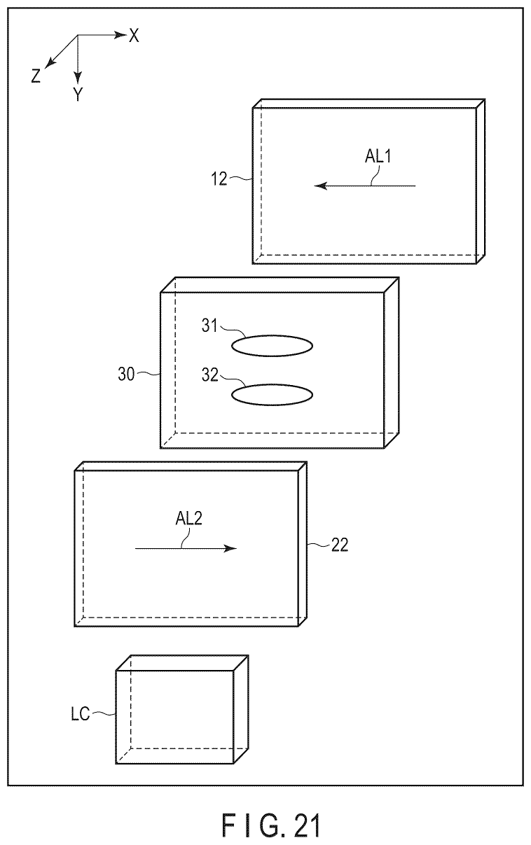

FIG. 21 is an exploded perspective view showing parts of the electronic device EA according to the third embodiment, illustrating alignment films 12 and 22, a liquid crystal layer 30, and a light control panel LC.

As shown in FIG. 21, rubbing is applied to an alignment film (rubbing alignment film) 12 in a first treatment direction AL1, and rubbing is applied to an alignment film (rubbing alignment film) 22 in a second treatment direction AL2. In the present embodiment, the first treatment direction AL1 is a direction which is opposite to the first direction X, and the second treatment direction AL2 is a direction which is the same as the first direction X. Since initial alignment directions of the plurality of liquid crystalline molecules 32 can be aligned in the same direction, the transmittance can be increased.

However, the first treatment direction AL1 and the second treatment direction AL2 may be the same directions. In addition, each of the alignment films 12 and 22 may be subjected to not rubbing, but a photo-alignment treatment. In this case, a direction in which the alignment film (photo-alignment film) 12 is subjected to the alignment treatment by a photo-alignment method and a direction in which the alignment film (photo-alignment film) 22 is subjected to the alignment treatment by a photo-alignment method may be parallel to the first direction X. Alternatively, one of the alignment film 12 and the alignment film 22 may be a photo-alignment film, and the other may be a rubbing alignment film.

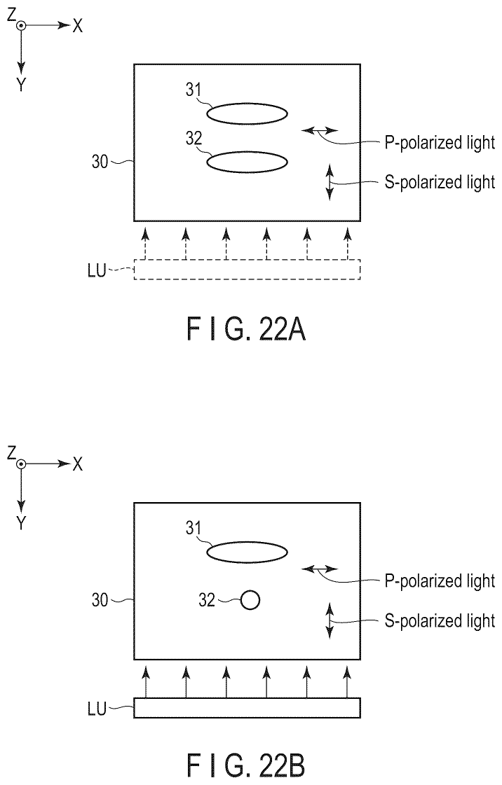

FIG. 22A is a diagram schematically showing a liquid crystal layer 30 in a transparent state and a light source unit LU. FIG. 22B is a diagram schematically showing a liquid crystal layer 30 in a scattered state and a light source unit LU.

As shown in FIG. 22A, the liquid crystal layer 30 in the transparent state is in a state in which the second transparent voltage VA2 is applied to the liquid crystal layer 30. In plan view, a long axis of the liquid crystalline polymer 31 and a long axis of the liquid crystalline molecule 32 are parallel to the first direction X. For the plurality of liquid crystalline molecules 32, a director of each liquid crystal area 3 to which the transparent voltage (second transparent voltage VA2) is applied is parallel to the first direction X in plan view.

There is almost no refractive index difference between the liquid crystalline polymer 31 and the liquid crystalline molecules 32. The liquid crystal layer 30 in the transparent state can transmit the external light beam while hardly scattering the external light beam. Even if the illumination light of the light source unit LU is made incident on the liquid crystal layer 30 to which the second transparent voltage VA2 is applied, the liquid crystal layer 30 transmits the illumination light while hardly scattering the illumination light.

As shown in FIG. 22B, the liquid crystal layer 30 in the scattered state is in a state in which the scattering voltage VB is applied to the liquid crystal layer 30. There is a large refractive index difference between the liquid crystalline polymer 31 and the liquid crystalline molecule 32. The light to be made incident on the liquid crystal layer 30 in the scattered state has different parallelisms (degrees of scattering) in accordance with the polarization state as will be described later.

In addition, even if the illumination light of the light source unit LU is made incident on the liquid crystal layer 30 to which the scattering voltage VB is applied, the liquid crystal layer 30 scatters the illumination light. A direction in which the light source unit LU emits light to the display area DA of the display panel PNL is desirably orthogonal to the first treatment direction AL1 and the second treatment direction AL2, in plan view. In other words, a direction in which the light source unit LU emits light to the display area DA of the display panel PNL is desirably orthogonal to a director of each liquid crystal area 3 to which the transparent voltage (second transparent voltage VA2) is applied, in plan view. As a result, the light emitted from the light source unit LU can be efficiently extracted to the outside of the display panel PNL.

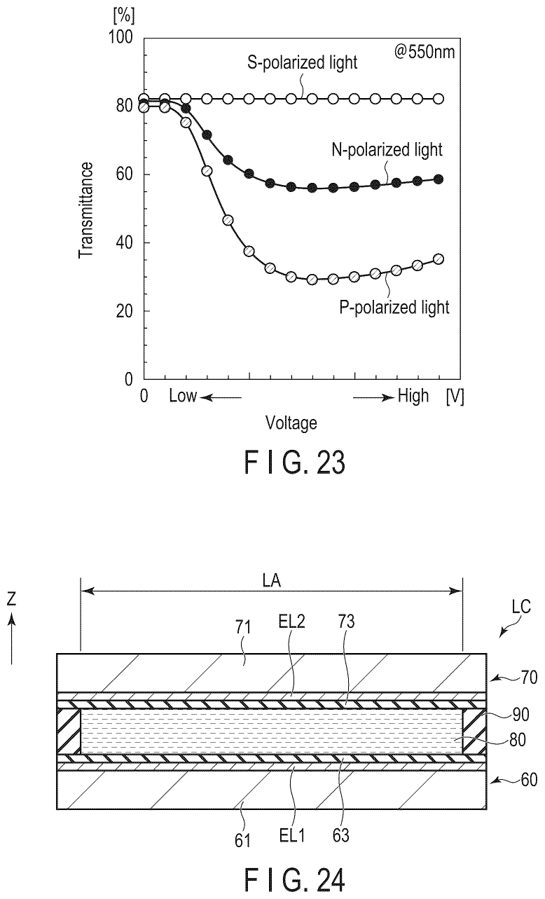

FIG. 23 is a graph showing change in transmittance to voltage in S-polarized light, P-polarized light, and N-polarized light. As shown in FIG. 23, it can be understood that light in a certain polarized state (S-polarized light) can be transmitted through the display panel PNL (liquid crystal layer 30) regardless of a value of the voltage to be applied to the liquid crystal layer 30. In other words, even if the scattering voltage VB is applied, the first transparent voltage VA1 is applied, or the second transparent voltage VA2 is applied to the liquid crystal layer 30, there is almost no change in the parallelism (degree of scattering) of the S-polarized light transmitted through the liquid crystal layer 30.

FIG. 24 is a cross-sectional view showing the light control panel LC of the electronic device EA according to the third embodiment. As shown in FIG. 24, the light control panel LC comprises a first substrate (first control substrate) 60, a second substrate (second control substrate) 70, a liquid crystal layer (control liquid crystal layer) 80, and the like.

The first substrate 60 comprises a transparent substrate 61, a first control electrode EL1, an alignment film (first control alignment film) 63, and the like. The second substrate 70 comprises a transparent substrate 71, a second control electrode EL2, an alignment film (second control alignment film) 73, and the like. The first control electrode EL1 and the second control electrode EL2 are formed of, for example, a transparent conductive material such as ITO or IZO, and are located in the light control area LA.

In the present embodiment, the first substrate 60 includes the single first control electrode EL1, but may include a plurality of electrically independent first control electrodes EL1. Each of the alignment film 63 and the alignment film 73 is in contact with the liquid crystal layer 80.

The liquid crystal layer 80 is located in at least the light control area LA. The liquid crystal layer 80 contains a polymer dispersed liquid crystal, and is held between the first substrate 60 and the second substrate 70. The liquid crystal layer 80 of the present embodiment uses reverse mode polymer dispersed liquid crystal (R-PDLC). Unlike the present embodiment, the liquid crystal layer 80 may use normal polymer dispersed liquid crystal.

The first substrate 60 and the second substrate 70 are bonded by a sealing material 90. The liquid crystal layer 80 is formed in a space surrounded by the first substrate 60, the second substrate 70, and the sealing material 90.

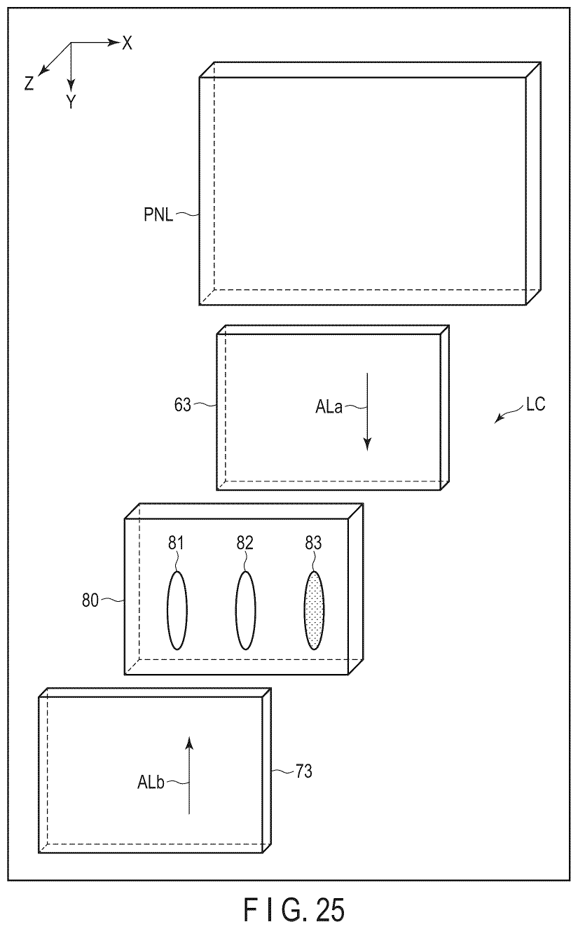

FIG. 25 is an exploded perspective view showing a part of the electronic device EA according to the third embodiment, illustrating a display panel PNL, the alignment films 63 and 73, and the liquid crystal layer 80.

As shown in FIG. 25, the liquid crystal layer 80 includes liquid crystalline polymers 81, liquid crystalline molecules 82, and dichroic dye molecules 83. For this reason, dichroic dye is contained in the liquid crystal layer 80. The dichroic dye is, for example, black dye. For this reason, the controller CON can switch the light control panel LC (liquid crystal layer 80) to a transmissive state or a light-shielding state.

Each of the alignment film 63 and the alignment film 73 is a horizontal alignment film. The alignment film (rubbing alignment film) 63 is subjected to rubbing in a third treatment direction ALa, and the alignment film (rubbing alignment film) 73 is subjected to rubbing in a fourth treatment direction ALb. In the present embodiment, the third treatment direction ALa is the same direction as the second direction Y, and the fourth treatment direction ALb is a direction opposite to the second direction Y.

However, the third treatment direction ALa and the fourth treatment direction ALb may be the same directions. Alternatively, each of the alignment films 63 and 73 may be subjected to not rubbing, but photo-alignment treatment. In this case, a direction in which the alignment film (photo-alignment film) 63 is subjected to the alignment treatment by a photo-alignment method and a direction in which the alignment film (photo-alignment film) 73 is subjected to the alignment treatment by a photo-alignment method may be parallel to the second direction Y. Alternatively, one of the alignment film 63 and the alignment film 73 may be a photo-alignment film, and the other may be a rubbing alignment film.

The liquid crystalline molecule 82 is a positive liquid crystalline molecule having positive dielectric anisotropy.

Unlike the present embodiment, however, the alignment films 63 and 73 may be vertical alignment films that subject the liquid crystalline polymer 81, the liquid crystalline molecule 82, and the dichroic dye molecule 83 to initial alignment along the third direction Z. Alternatively, the liquid crystalline molecule 82 may be a negative liquid crystalline molecule having negative dielectric anisotropy.

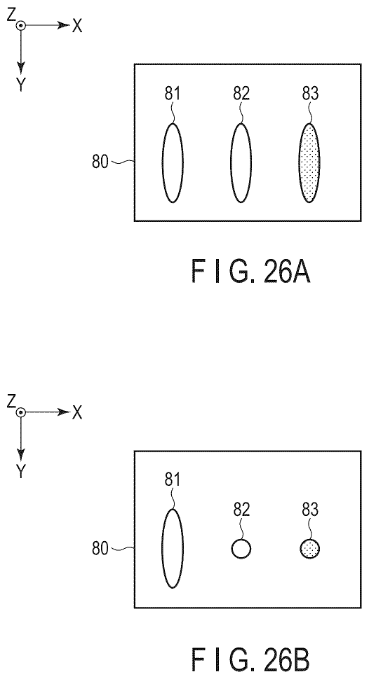

FIG. 26A is a diagram schematically showing the liquid crystal layer 80 in a state in which the light control panel LC of the electronic device EA according to the third embodiment is switched to a light-shielding state. FIG. 26B is a diagram schematically showing the liquid crystal layer 80 in a state in which the light control panel LC of the electronic device EA according to the third embodiment is switched to a transmissive state.

As shown in FIG. 26A, the liquid crystal layer 80 in the light-shielding state is considered to be in a state in which no voltage is applied to the liquid crystal layer 80 (0V). In plan view, a long axis of the liquid crystalline polymer 81, a long axis of the liquid crystalline molecule 82, and a long axis of the dichroic dye molecule 83 are parallel to the second direction Y. When the light control panel LC is switched to the light-shielding state, a control director, which is a director of the liquid crystal layer 80, intersects the direction of the light traveling from the display panel PNL to the front of the second display surface DS2 (i.e., the third direction Z). For example, the control director is orthogonal to the traveling direction of the light (i.e., the third direction Z).

When a potential difference between the first control electrode EL1 and the second control electrode EL2 is 0V, the alignment film 63 and the alignment film 73 urge the alignment restriction force to act on the liquid crystalline molecule 82 such that the control director is perpendicular to the direction (third direction Z) in which the alignment film 63 faces the alignment film 73. Since the light traveling from the display area DA toward the front of the second display surface DS2 can be absorbed by the dichroic dye molecules 83, the light control panel LC becomes a light-shielding state.

As shown in FIG. 26B, the liquid crystal layer 80 in the transmissive state is considered to be in a state in which a voltage (for example, a voltage exceeding 8V) is applied to the liquid crystal layer 80. In plan view, the long axis of the liquid crystalline polymer 81 remains parallel to the second direction Y. The electric field which occurs between the first control electrode EL1 and the second control electrode EL2 acts on the liquid crystalline molecule 82, and the long axis of the liquid crystalline molecule 82 thereby becomes parallel to the third direction Z. Since the dichroic dye molecule 83 is aligned in accordance with the liquid crystalline molecule 82, the long axis of the dichroic dye molecule 83 becomes parallel to the third direction Z.

When the light control panel LC is switched to the transmissive state, the director (control director) of the liquid crystal layer 80 is parallel to the front of the second display surface DS2 from the display panel PNL (i.e., the third direction Z). The traveling direction of the light is parallel to the long axis of the dichroic dye molecule 83. Since no absorption of light traveling from the display area DA to the front of the second display surface DS2 occurs at the liquid crystal layer 80 in FIG. 26B, the light control panel LC becomes a transmissive state.

The electronic device EA according to the third embodiment is configured as described above.

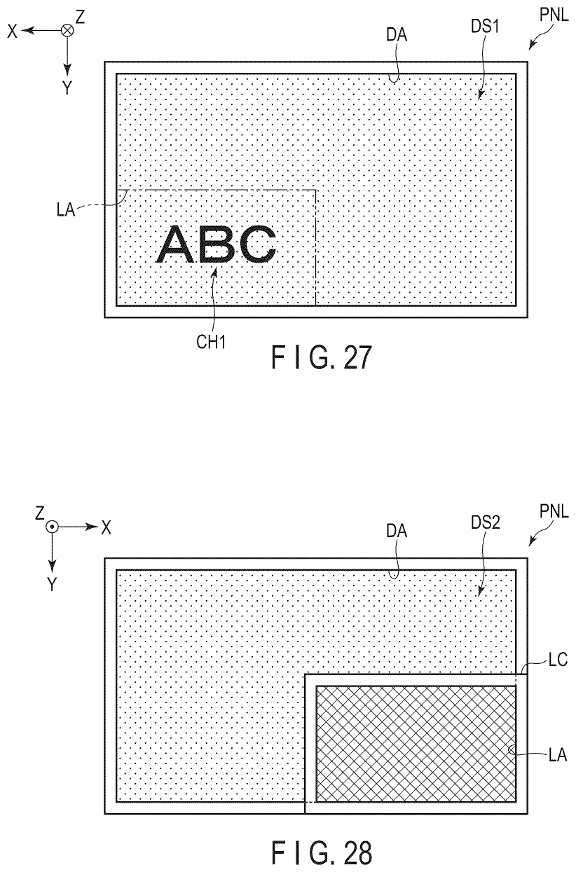

An example in which the teacher in front of the first display surface DS1 inputs the character string “ABC” to the light control area LA of the sensor SE1 and switches the light control panel LC to the light-shielding state will be described. FIG. 27 is a plan view showing the display panel PNL from the first display surface DS1 side, in the electronic device EA according to the third embodiment, illustrating an example of use of the electronic device EA and a state in which the first character CH1 input to the sensor SE1 by the teacher is displayed in front of the light control area LA of the first display surface DS1.

As shown in FIG. 27, the controller CON generates the first image data based on the input information detected by the sensor SE1, stores the above first image data in the memory unit ME, and displays the first character CH1 based on the above first image data stored in the memory unit ME, in front of the light control area LA of the display area DA on the first display surface DS1 of the display panel PNL.

The first character CH1 is a character string “ABC”. When the light control area LA is viewed from the front of the first display surface DS1, the character string “ABC” of the first character CH1 displayed in the light control area LA of the display area DA overlaps with the character string “ABC” input to the sensor SE1 by the teacher. For this reason, the teacher can easily identify the first character CH1 in the light control area LA.

FIG. 28 is a plan view showing the display panel and the light control panel LC from the second display surface DS2 side, in the electronic device EA according to the third embodiment, illustrating an example of use of the electronic device EA, and a state in which the first character CH1 displayed in front of the light control area LA of the second display surface DS2 is hidden by the light control panel LC.

As shown in FIG. 28, the controller CON switches the light control panel LC to the light-shielding state. The first character CH1 displayed in front of the light control area LA on the second display surface DS2 can be therefore hidden by the light control panel LC. Therefore, a situation in which the first character CH1 is recognized by the students can be avoided.

The same advantages as those of the above-described first embodiment can also be obtained from the third embodiment configured as described above. The teacher can selectively show images to the students.

In the third embodiment, the light control panel LC is a modulated panel. However, the light control panel LC may be switchable between a transmissive state and a light-shielding state. The light control panel LC may be a light shutter panel. Examples of the above light shutter panel include a panel to which electrophoresis, micro-electromechanical systems (MEMS), electrochromism, or the like can be applied.

### Fourth Embodiment

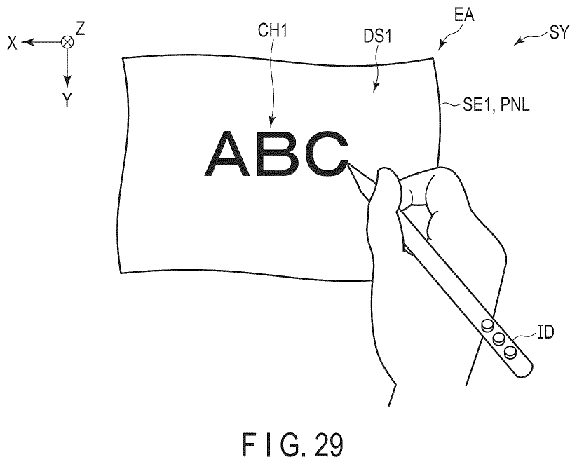

Next, a fourth embodiment will be described. An electronic device EA is configured similarly to the electronic device EA of each of the above-described embodiments except for a configuration to be described in the fourth embodiment. FIG. 29 is a view showing a part of a display system SY according to the fourth embodiment, showing a display panel PNL viewed from a side of a sensor SE1 and a first display surface DS1 of the electronic device EA, and an input device ID, illustrating an example of use of the display system SY, and a state in which the input device ID using an input signal with color information displays a first character CH1 input to the sensor SE1 in a color other than achromatic on the display panel PNL.

As shown in FIG. 29, the display system SY comprises an electronic device EA and an input device ID. The input device ID can output input signals with color information. For example, the teacher can make the output input signal include information on various display colors such as red, green, and blue, by operating a button on the input device ID. The input device ID can output, for example, a first input signal with information on the first display color. When the input information detected by the sensor SE1 is the first input signal with the information on the first display color, the controller CON can display the first character CH1 of the first display color.

The teacher can change the display color of the input signal to be output, by operating a button of the input device ID. For example, the input device ID may output a second input signal with the information on the second display color. When the input information detected by the sensor SE1 is the second input signal with the information on the second display color, the controller CON can display the character of the second display color.

The same advantages as those of the above-described first embodiment can also be obtained from the fourth embodiment configured as described above. The teacher can use different colors when displaying the character in the display area DA.

### Fifth Embodiment

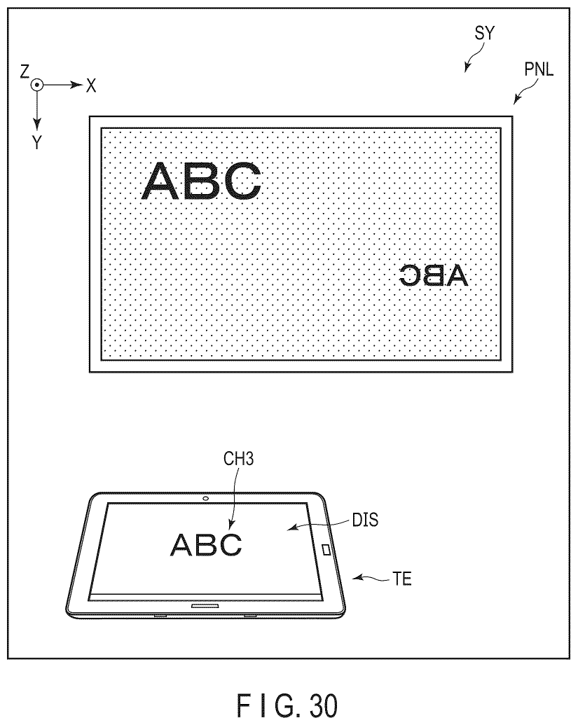

Next, a fifth embodiment will be described. An electronic device EA is configured similarly to the electronic device EA of each of the above-described embodiments except for a configuration to be described in the fifth embodiment. FIG. 30 is a view showing a part of a display system SY according to the fifth embodiment, showing a display panel PNL from a second display surface DS2 side of an electronic device EA, and a communication terminal TE, and illustrating an example of use of the display system SY, and a state in which a third character CH3 displayed on the communication terminal TE is also displayed in a display area DA of the display panel PNL, by transmitting an input signal from the communication terminal TE to the electronic device EA.

As shown in FIG. 30, the display system SY comprises the electronic device EA and the communication terminal TE. The communication terminal TE includes a display unit DIS that displays the input third character CH3. For example, the communication unit CM of the electronic device EA shown in FIG. 1 can communicate with the communication terminal TE.

When an input signal indicating the third character CH3 is transmitted from the communication terminal TE to the electronic device EA, the controller CON displays the third character CH3 in the display area DA of the display panel PNL. More specifically, the controller CON generates the image data based on the input information received by the communication unit CM, stores the above image data in the memory unit ME, and displays the third character CH3 based on the above image data stored in the memory unit ME, in front of the second display surface DS2 in the display area DA of the display panel PNL.

For this reason, it is possible make not only the student who operates the communication terminal TE but also all students looking at the second display surface DS2 visually recognize the third character CH3. Incidentally, the third character CH3 displayed on the display unit DIS of the communication terminal TE and the third character CH3 displayed in front of the second display surface DS2 are, for example, similar to each other.

In the present embodiment, the controller CON further displays a fourth character CH4, which is a character obtained by horizontally flipping the third character CH3, in the display area DA of the display panel PNL. Incidentally, the third character CH3 displayed in front of the second display surface DS2 and the fourth character CH4 displayed in front of the first display surface DS1 are, for example, similar to each other. For this reason, the teacher in front of the first display surface DS1 can also desirably identify the fourth character CH4.

The same advantages as those of the above-described first embodiment can also be obtained from the fifth embodiment configured as described above. It is possible to display a character input to the communication terminal TE, in the display area DA of the electronic device EA. In addition, it is also possible to display a process of inputting a character to the communication terminal TE, in the display area DA.

### Modified Example 1 of First Embodiment

Next, modified example 1 of the first embodiment will be described. The electronic device EA is configured in the same manner as the above-described first embodiment except for constituent elements to be described in modified example 1.

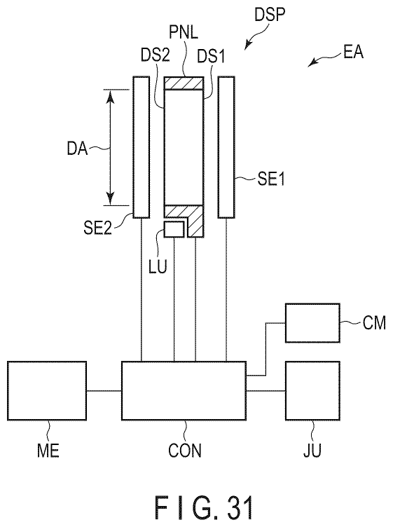

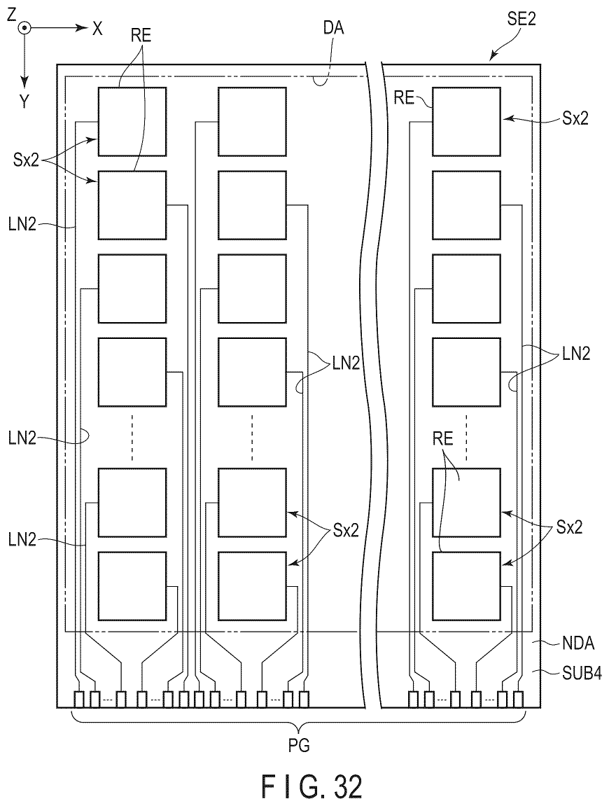

As shown in FIG. 31, the electronic device EA may further comprise a sensor SE2 as a second sensor. The sensor SE2 is opposed to at least the display area DA. The sensor SE1 is opposed to the first display surface DS1 of the display panel PNL. The sensor SE2 is opposed to the second display surface DS2 of the display panel PNL.

As shown in FIG. 32, the sensor SE2 is a sensor which can detect input information and is, for example, a capacitive sensor. The sensor SE2 includes a transparent fourth substrate SUB4, a plurality of second detection electrodes Sx2, and a plurality of wiring lines LN2. The plurality of second detection electrodes Sx2 are arranged to be opposed to at least the display area DA. Each of the second detection electrodes Sx2 is formed by a transparent electrode RE. As described above, the sensor SE2 is configured in the same manner as the sensor SE1.

For example, the teacher in front of the first display surface DS1 can input characters by handwriting to the sensor SE1, and the students in front of the second display surface DS2 can input characters by handwriting to the sensor SE2. Incidentally, the electronic device EA of not only the first embodiment, but each of the embodiments may further comprise the sensor SE2.

### Modified Example 2 of First Embodiment

Next, modified example 2 of the first embodiment will be described. The electronic device EA is configured in the same manner as the above-described first embodiment except for constituent elements to be described in modified example 2.

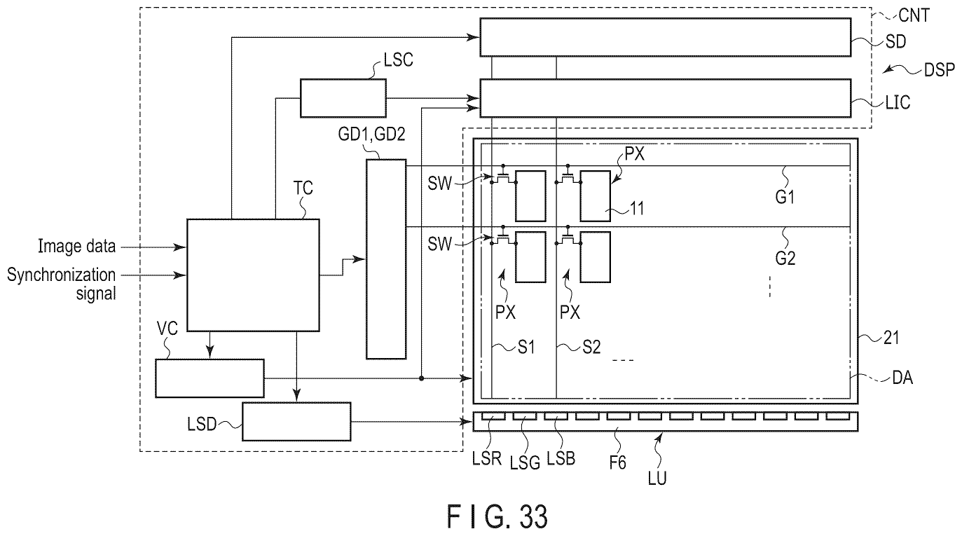

As shown in FIG. 33, a configuration of the display device DSP is different from that shown in FIG. 4 in that a controller CNT comprises a level conversion circuit (level shift circuit) LSC and a Vcom pull-in circuit LIC.

A common voltage (Vcom) supplied from a Vcom circuit VC is supplied to a common electrode 21 and also to the Vcom pull-in circuit LIC. The Vcom pull-in circuit LIC is intervened between a source driver SD and each of source lines S. The Vcom pull-in circuit LIC supplies a video signal output from the source driver SD to each of the source lines S. In addition, the Vcom pull-in circuit LIC can also supply a common voltage from the Vcom circuit VC to each of the source lines S.

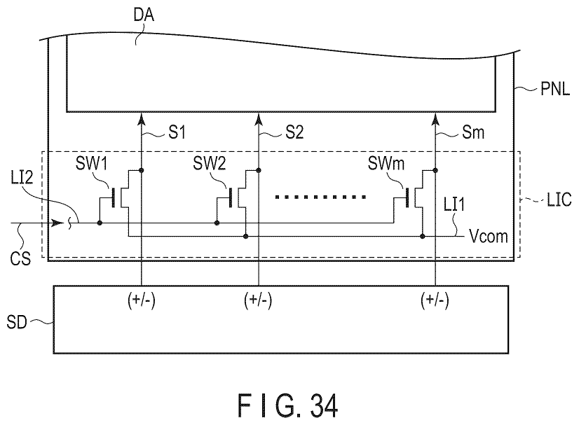

FIG. 34 is a diagram showing a configuration example of the Vcom pull-in circuit LIC shown in FIG. 33. As shown in FIG. 34, the Vcom pull-in circuit LIC comprises switching elements SW1 to SWm. The switching elements SW1 to SWm are disposed on, for example, a first substrate SUB1 of a display panel PNL. The switching elements SW1 to SWm have input terminals (sources) connected to a wiring line LI1, output terminals (drains) connected to the source lines S1 to Sm, respectively, and control terminals (gates) connected to a wiring line LI2.

The Vcom circuit VC shown in FIG. 33 supplies a common voltage Vcom to the wiring line LI1. Incidentally, this operation can be applied to, for example, the drive in a reset period Pr. In addition, a timing controller TC outputs a control signal CS to a level conversion circuit LSC when executing transparent drive. The level conversion circuit LSC converts this control signal CS into a voltage of a predetermined level and supplies the voltage to the wiring line LI2. When the control signal CS is supplied to the wiring line LI2, the wiring line LI1 and each of the source lines S1 to Sm become conductive, and the common voltage Vcom of the wiring line LI1 is supplied to each of the source lines S1 to Sm.

Thus, when the gate signal is supplied to each of gate lines G1 to Gn in a state in which the common voltage Vcom is supplied to each of the source lines S1 to Sm, the common voltage Vcom of each of the source lines S1 to Sm is supplied to each of pixel electrodes 11. In other words, a potential difference between each of the pixel electrodes 11 and the common electrode 21 becomes 0V (second transparent voltage VA2). According to the configuration of the modified example 2, a circuit for supplying the voltage (for example, the common voltage Vcom) for transparent drive to the source driver SD and the like do not need to be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. A plurality of embodiments can also be combined as needed.

For example, the display device DSP may be configured without the light source unit LU. In this case, the display device DSP may comprise a liquid crystal display panel using a liquid crystal other than the polymer dispersed liquid crystal and a polarizer, instead of the display panel PNL using the polymer dispersed liquid crystal. Alternatively, the display device DSP may comprise a transparent organic EL display panel, instead of the display panel PNL using the polymer dispersed liquid crystal.

Pieces of sub-frame data stored in the line memories 52R, 52G, and 52B are examples of first sub-frame data representing an image of a first color, second sub-frame data representing an image of a second color, and third sub-frame data representing an image of a third color.

The first color, the second color, and the third color are not limited to red, blue, and green colors. In addition, the light source unit LU may comprise light-emitting elements LS of two or less colors or may comprise light-emitting elements LS of four or more colors. Alternatively, the light source unit LU may comprise a light emitting element LS of white color. The number of line memories, the number of the sub-frame data, and the number of the sub-frame periods may be increased or reduced in accordance with the number of types (number of colors) of the light-emitting elements LS.

A normal mode polymer dispersed liquid crystal may be used as the liquid crystal layer 30. The liquid crystal layer 30 maintains parallelism of light incident when the applied voltage is high or scatters the incident light when the applied voltage is low.

The electronic device EA and the display system SY described above can be used outside of school classes and may be used in office meetings, lectures, licensing centers, cooking classes, and the like.

The contents of the invention will be described below.
(1) An electronic device comprising:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit; and
a controller controlling drive of the plurality of pixel electrodes, the common electrode, the plurality of first detection electrodes, and the memory unit,
wherein
during a first period, the controller generates first image data based on the input information detected by the first sensor, stores the first image data in the memory unit, and displays a first character based on the first image data stored in the memory unit, in the display area of the display panel,
during a second period following the first period, the controller generates second image data based on the first image data stored in the memory unit, and records the second image data in the memory unit,
during a third period following the second period, the controller displays a second character based on the second image data instead of the first character, in the display area of the display panel, and
the second character is a character obtained by flipping the first character.
(2) The electronic device of (1), wherein
the controller displays the second character after a specific period from timing at which obtaining the input information is ended.
(3) The electronic device of (1), further comprising:
a determination unit having drive controlled by the controller and detecting a flip signal transmitted by a user's input,
wherein
when the determination unit determines that the flip signal is detected, the controller displays the second character.
(4) An electronic device comprising:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode, the display area including a first display area and a second display area;
a first sensor including a plurality of first detection electrodes opposed to at least the display area and detecting input information;
a memory unit; and
a controller controlling drive of the plurality of pixel electrodes, the common electrode, the plurality of first detection electrodes, and the memory unit,
wherein
the controller generates first image data based on the input information detected by the first sensor in the first display area, stores the first image data in the memory unit, and displays a first character based on the first image data stored in the memory unit, in the first display area of the display panel,
the controller generates second image data based on the first image data stored in the memory unit, and records the second image data in the memory unit,
the controller displays a second character based on the second image data, in the second display area of the display panel, and
the second character is a character obtained by flipping the first character.
(5) An electronic device comprising:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit;
a light control panel opposed to the second display surface of the display panel, made to overlap with a light control area which is at least a partial area of the display area, and switched to a transmissive state in which light made incident from the light control area side of the second display surface is transmitted and a light-shielding state in which the light is blocked;
a controller controlling drive of the plurality of pixel electrodes, the common electrode, the plurality of first detection electrodes, the memory unit, and the light control panel,
wherein
the controller displays a character based on image data stored in the memory unit, in the light control area of the display panel, displays the character in front of the light control area of the first display surface, switches the light control panel to the light-shielding state, and and hides the character displayed in front of the light control area of the second display surface by the light control panel.
(6) The electronic device of one of (1) to (5), further comprising:
a second sensor including a plurality of second detection electrodes opposed to at least the display area and detecting input information,
wherein
the first sensor is opposed to the first display surface of the display panel, and
the second sensor is opposed to the second display surface of the display panel.
(7) A display system comprising:
the electronic device of one of (1) to (5); and
an input device capable of outputting an input signal with color information,
wherein
the electronic device further comprises a light source unit having drive controlled by the controller, located output an area opposed to the display area of the display panel, and emitting light of a color other than an achromatic color to the display function layer,
the input device outputs a first input signal with information on a first display color and,
when the input information detected by the first sensor is the first input signal with the information on the first display color, the controller displays a character of the first display color.
(8) The display system of (7), wherein
the input device outputs a second input signal with information on a second display color and,
when the input information detected by the first sensor is the second input signal with the information on the second display color, the controller displays a character of the second display color.
(9) The display system of (7), wherein
the electronic device further comprises a second sensor including a plurality of second detection electrodes opposed to at least the display area and detecting input information,
the first sensor is opposed to the first display surface of the display panel, and
the second sensor is opposed to the second display surface of the display panel.
(10) A display system comprising:
an electronic device; and
a communication terminal including a display unit displaying an input character,
wherein
the electronic device comprises:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit;
a communication unit capable of communicating with the communication terminal; and
a controller controlling drive of the plurality of pixel electrodes, the common electrode, the plurality of first detection electrodes, the memory unit, and the communication unit, and
when transmitting an input signal indicating the character from the communication terminal to the electronic device, the controller generates image data based on the input signal received by the communication unit, stores the image data in the memory unit, and displays the character based on the image data stored in the memory unit, in the display area of the display panel.
(11) The display system of (10), wherein
the electronic device further comprises a second sensor including a plurality of second detection electrodes opposed to at least the display area and detecting input information,
the first sensor is opposed to the first display surface of the display panel, and
the second sensor is opposed to the second display surface of the display panel.

What is claimed is:

1. An electronic device comprising:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit; and
a controller controlling drive of the plurality of pixel electrodes, the common electrode, the plurality of first detection electrodes, and the memory unit,
wherein
during a first period, the controller generates first image data based on the input information detected by the first sensor, stores the first image data in the memory unit, and displays a first character based on the first image data stored in the memory unit, in the display area of the display panel,
during a second period following the first period, the controller generates second image data based on the first image data stored in the memory unit, and records the second image data in the memory unit,
during a third period following the second period, the controller displays a second character based on the second image data instead of the first character, in the display area of the display panel, and
the second character is a character obtained by flipping the first character.

2. The electronic device of claim 1, wherein
the controller displays the second character after a specific period from timing at which obtaining the input information is ended.

3. The electronic device of claim 2, further comprising:
a second sensor including a plurality of second detection electrodes opposed to at least the display area and detecting input information,
wherein
the first sensor is opposed to the first display surface of the display panel, and
the second sensor is opposed to the second display surface of the display panel.

4. The electronic device of claim 1, further comprising:
a determination unit having drive controlled by the controller and detecting a flip signal transmitted by a user's input,
wherein
when the determination unit determines that the flip signal is detected, the controller displays the second character.

5. The electronic device of claim 4, further comprising:
a second sensor including a plurality of second detection electrodes opposed to at least the display area and detecting input information,
wherein
the first sensor is opposed to the first display surface of the display panel, and
the second sensor is opposed to the second display surface of the display panel.

6. The electronic device of claim 1, further comprising:
a second sensor including a plurality of second detection electrodes opposed to at least the display area and detecting input information,
wherein
the first sensor is opposed to the first display surface of the display panel, and
the second sensor is opposed to the second display surface of the display panel.

7. A display system comprising:
an electronic device; and
an input device capable of outputting an input signal with color information,
wherein
the electronic device comprises:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit;
a controller controlling drive of the plurality of pixel electrodes, the common electrode, the plurality of first detection electrodes, and the memory unit; and
a light source unit having drive controlled by the controller, being located outside an area opposed to the display area of the display panel, and emitting light of a color other than an achromatic color to the display function layer,
during a first period, the controller generates first image data based on the input information detected by the first sensor, stores the first image data in the memory unit, and displays a first character based on the first image data stored in the memory unit, in the display area of the display panel,
during a second period following the first period, the controller generates second image data based on the first image data stored in the memory unit, and records the second image data in the memory unit,
during a third period following the second period, the controller displays a second character based on the second image data instead of the first character, in the display area of the display panel,
the second character is a character obtained by flipping the first character,
the input device outputs a first input signal with information on a first display color, and
when the input information detected by the first sensor is the first input signal with the information on the first display color, the controller displays a character of the first display color.

8. The display system of claim 7, wherein
the input device outputs a second input signal with information on a second display color, and
when the input information detected by the first sensor is the second input signal with the information on the second display color, the controller displays a character of the second display color.

9. The display system of claim 7, wherein
the electronic device further comprises a second sensor including a plurality of second detection electrodes opposed to at least the display area and detecting input information,
the first sensor is opposed to the first display surface of the display panel, and
the second sensor is opposed to the second display surface of the display panel.

10. A display system comprising:
an electronic device; and
a communication terminal including a display unit displaying an input character,
wherein
the electronic device comprises:
a display panel including a plurality of pixel electrodes located in a display area, a common electrode located in the display area, a display function layer located in the display area and including a plurality of display function areas, a first display surface, and a second display surface on a side opposite to the first display surface, each of the display function areas being switched to a transparent state in which light made incident is transmitted, and a scattered state in which the incident light is scattered by application of a voltage applied between a corresponding pixel electrode of the plurality of pixel electrodes and the common electrode;
a first sensor including a plurality of first detection electrodes opposed to at least the display area and detecting input information;
a memory unit;
a communication unit capable of communicating with the communication terminal; and
a controller controlling drive of the plurality of pixel electrodes, the common electrode, the plurality of first detection electrodes, the memory unit, and the communication unit, and
when transmitting an input signal indicating the character from the communication terminal to the electronic device, the controller generates image data based on the input signal received by the communication unit, stores the image data in the memory unit, and displays the character based on the image data stored in the memory unit, in the display area of the display panel.

11. The display system of claim 10, wherein
the electronic device further comprises a second sensor including a plurality of second detection electrodes opposed to at least the display area and detecting input information,
the first sensor is opposed to the first display surface of the display panel, and
the second sensor is opposed to the second display surface of the display panel.
